(19) United States
(12) Patent Application Publication
(10) Pub. No.: US 2026/0261303 A1
(43) Pub. Date: Sep. 3, 2026

(54) NODES, AND METHODS FOR PROPRIETARY ML-BASED CSI REPORTING

(71) Applicant: Telefonaktiebolaget LM Ericsson (publ), Stockholm (SE)

(72) Inventors: Roy TIMO, Kungsängen (SE); Lars LINDBOM, Karlstad (SE); Mattias FRENNE, Uppsala (SE); Daniel CHEN LARSSON, Lund (SE)

(21) Appl. No.: 18/718,162

(22) PCT Filed: Dec. 6, 2022
(86) PCT No.: PCT/SE2022/051146

§ 371 Date: Jun. 10, 2024

Related U.S. Application Data
(60) Provisional application No. 63/265,417, filed on Dec. 15, 2021.

(51) Int. Cl. H04B 7/06; G06N 3/0455; H04L 41/16

(52) U.S. Cl. CPC H04B 7/0626; G06N 3/0455; H04L 41/16

(57) ABSTRACT

A method, performed by a first node comprising an AE-encoder, for training the AE-encoder to provide encoded CSI. The method includes providing AE-encoder data to a second node having an AE-decoder and having access to channel data representing a communications channel between a first communications node and a second communications node. The AE-encoder data includes encoder output data computed with the AE-encoder based on the channel data. The method further includes receiving, from the second node, training assistance information. The method further includes determining, based on the training assistance information, whether or not to continue the training by updating encoder parameters of the AE-encoder based on the received training assistance information.

### TECHNICAL FIELD

The embodiments herein relate to nodes and methods for proprietary ML-based CSI reporting. A corresponding computer program and a computer program carrier are also disclosed.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas. Each service area or cell area may provide radio coverage via a beam or a beam group. Each service area or cell area is typically served by a radio access node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio access node. The radio access node communicates over an air interface operating on radio frequencies with the wireless device within range of the radio access node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio access nodes are directly connected to the EPC core network rather than to RNCs used in 3G networks. In general, in E-UTRAN/LTE the functions of a 3G RNC are distributed between the radio access nodes, e.g. eNodeBs in LTE, and the core network. As such, the RAN of an EPS has an essentially “flat” architecture comprising radio access nodes connected directly to one or more core networks, i.e. they are not connected to RNCs. To compensate for that, the E-UTRAN specification defines a direct interface between the radio access nodes, this interface being denoted the X2 interface.

### Wireless Communication Systems in 3GPP

FIG. 1 illustrates a simplified wireless communication system. Consider the simplified wireless communication system in FIG. 1, with a UE 12, which communicates with one or multiple access nodes 103-104, which in turn is connected to a network node 106. The access nodes 103-104 are part of the radio access network 10.

For wireless communication systems pursuant to 3GPP Evolved Packet System, (EPS), also referred to as Long Term Evolution, LTE, or 4G, standard specifications, such as specified in 3GPP TS 36.300 and related specifications, the access nodes 103-104 corresponds typically to Evolved NodeBs (eNBs) and the network node 106 corresponds typically to either a Mobility Management Entity (MME) and/or a Serving Gateway (SGV). The eNB is part of the radio access network 10, which in this case is the E-UTRAN (Evolved Universal Terrestrial Radio Access Network), while the MME and SGW are both part of the EPC (Evolved Packet Core network). The eNBs are inter-connected via the X2 interface, and connected to EPC via the S1 interface, more specifically via S1-C to the MME and S1-U to the SGW.

For wireless communication systems pursuant to 3GPP 5G System, 5GS (also referred to as New Radio, NR, or 5G) standard specifications, such as specified in 3GPP TS 38.300 and related specifications, on the other hand, the access nodes 103-104 corresponds typically to an 5G NodeB (gNB) and the network node 106 corresponds typically to either an Access and Mobility Management Function (AMF) and/or a User Plane Function (UPF). The gNB is part of the radio access network 10, which in this case is the NG-RAN (Next Generation Radio Access Network), while the AMF and UPF are both part of the 5G Core Network (5GC). The gNBs are inter-connected via the Xn interface, and connected to 5GC via the NG interface, more specifically via NG-C to the AMF and NG-U to the UPF.

To support fast mobility between NR and LTE and avoid change of core network, LTE eNBs may also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this document; however, it should be noted that most of the solutions/features described for LTE and NR in this document also apply to LTE connected to 5GC. In this document, when the term LTE is used without further specification it refers to LTE-EPC.

NR uses Orthogonal Frequency Division Multiplexing (OFDM) with configurable bandwidths and subcarrier spacing to efficiently support a diverse set of use-cases and deployment scenarios. With respect to LTE, NR improves deployment flexibility, user throughputs, latency, and reliability. The throughput performance gains are enabled, in part, by enhanced support for Multi-User Multiple-Input Multiple-Output (MU-MIMO) transmission strategies, where two or more UEs receives data on the same time frequency resources, i.e., by spatially separated transmissions.

A MU-MIMO transmission strategy will now be illustrated based on FIG. 2. FIG. 2 illustrates an example transmission and reception chain for MU-MIMO operations. Note that the order of modulation and precoding, or demodulation and combining respectively, may differ depending on the implementation of MU-MIMO transmission.

A multi-antenna base station with N_{TX} antenna ports is simultaneously, e.g., on the same OFDM time-frequency resources, transmitting information to several UEs: a sequence S⁽¹⁾ is transmitted to UE(1), S⁽²⁾ is transmitted to UE(2), and so on. An antenna port may be a logical unit which may comprise one or more antenna elements. Before modulation and transmission, precoding

$${W}_{V}^{( j )}$$

is applied to each sequence to mitigate multiplexing interference—the transmissions are spatially separated.

Each UE demodulates its received signal and combines receiver antenna signals to obtain an estimate Ŝ⁽ⁱ⁾ of the transmitted sequence. This estimate Ŝ⁽ⁱ⁾ for UE i may be expressed as (neglecting other interference and noise sources except the MU-MIMO interference)

$${\hat{S}}^{( i )} = {\underbrace{{W}_{U}^{( i )} {H}^{( i )} {W}_{V}^{( i )}}}_{\approx I} {S}^{( i )} + {W}_{U}^{( i )} {H}^{( i )} {\sum }_{j , j \neq i} {W}_{V}^{( j )} {S}^{( j )}$$

The second term represents the spatial multiplexing interference, due to MU-MIMO transmission, seen by UE(i). A goal for a wireless communication network may be to construct a set of precoders

$$\{ {W}_{V}^{( j )} \}$$

to meet a given target. One such target may be to make
the norm

$$‖ {H}^{( i )} {W}_{V}^{( i )} ‖$$

large (this norm represents the desired channel gain towards user i); and
the norm

$$‖ {H}^{( j )} {W}_{V}^{( i )} ‖$$

j≠i small (this norm represents the interference of user i's transmission received by user j). In other words, the precoder

$${W}_{V}^{( i )}$$

shall correlate well with the channel H⁽ⁱ⁾ observed by UE(i) whereas it shall correlate poorly with the channels observed by other UEs.

To construct precoders

$${W}_{V}^{( i )} ,$$

i=1, . . . , J that enable efficient MU-MIMO transmissions, the wireless communication network may need to obtain detailed information about the users' downlink (DL) channels H(i), i=1, . . . , J. The wireless communication network may for example need to obtain detailed information about all the users downlink channels H(i), i=1, . . . , J.

In deployments where full channel reciprocity holds, detailed channel information may be obtained from uplink (UL) Sounding Reference Signals (SRS) that are transmitted periodically, or on demand, by active UEs. The wireless communication network may directly estimate the uplink channel from SRS and, therefore (by reciprocity), the downlink channel H⁽ⁱ⁾.

However, the wireless communication network cannot always accurately estimate the downlink channel from uplink reference signals. Consider the following examples:
In frequency division duplex (FDD) deployments, the uplink and downlink channels use different carriers and, therefore, the uplink channel may not provide enough information about the downlink channel to enable MU-MIMO precoding.
In TDD deployments, the wireless communication network may only be able to estimate part of the uplink channel using SRS because UEs typically have fewer TX branches than RX branches (in which case only certain columns of the precoding matrix may be estimated using SRS). This situation is known as partial channel knowledge.

If the wireless communication network cannot accurately estimate the full downlink channel from uplink transmissions, then active UEs need to report channel information to the wireless communication network over the uplink control or data channels. In LTE and NR, this feedback is achieved by the following signalling protocol:
The wireless communication network transmits Channel State Information reference signals (CSI-RS) over the downlink using N ports.
The UE estimates the downlink channel (or important features thereof, such as eigenvectors of the channel or the Gram matrix of the channel, one or more eigenvectors that correspond to the largest eigenvalues of an estimated channel covariance matrix, one or more Discrete Fourier Transform (DFT) base vectors (described on the next page), or orthogonal vectors from any other suitable and defined vector space, that best correlates with an estimated channel matrix, or an estimated channel covariance matrix, the channel delay profile)) for each of the N antenna ports from the transmitted CSI-RS.
The UE reports CSI (e.g., channel quality index (CQI), precoding matrix indicator (PMI), rank indicator (RI)) to the wireless communication network over an uplink control channel and/or over a data channel.
The wireless communication network uses the UE's feedback, e.g., the CSI reported from the UE, for downlink user scheduling and MIMO precoding.

In NR, both Type I and Type II reporting is configurable, where the CSI Type II reporting protocol has been specifically designed to enable MU-MIMO operations from uplink UE reports, such as the CSI reports.

The CSI Type II normal reporting mode is based on the specification of sets of DFT basis functions in a precoder codebook. The UE selects and reports L DFT vectors from the codebook that best match its channel conditions like the classical codebook precoding matrix indicator (PMI) from earlier 3GPP releases. The number of DFT vectors L is typically 2 or 4 and it is configurable by the wireless communication network. In addition, the UE reports how the L DFT vectors should be combined in terms of relative amplitude scaling and co-phasing.

Algorithms to select L, the L DFT vectors, and co-phasing coefficients are outside the specification scope—left to UE and network implementation. Or, put another way, the 3gpp Rel. 16 specification only defines signaling protocols to enable the above message exchanges.

In the following, “DFT beams” will be used interchangeably with DFT vectors. This slight shift of terminology is for example appropriate whenever the base station has a uniform planar array with antenna elements separated by half of the carrier wavelength.

The CSI type II normal reporting mode is illustrated in FIG. 3 and described in 3gpp TS 38.214 “Physical layer procedures for data” (Release 16). The selection and reporting of the L DFT vectors bn and their relative amplitudes an, where n equals 0, 1, 2 and 3 In FIG. 3, is done in a wideband manner; that is, the same beams are used for both polarizations over the entire transmission frequency band. The selection and reporting of the DFT vector co-phasing coefficients are done in a subband manner; that is, DFT vector co-phasing parameters are determined for each of multiple subsets of contiguous subcarriers. The co-phasing parameters are quantized such that e^{jθ}^{ₙ} is taken from either a Quadrature phase-shift keying (QPSK) or 8-Phase Shift Keying (8PSK) signal constellation.

With k denoting a sub-band index, the precoder W_{V}[k] reported by the UE to the network can be expressed as follows:

$${W}_{V} [ k ] = {\sum }_{n} {b}_{n} {a}_{n} {e}^{j {θ}_{n} [ k ]} .$$

The Type II CSI report can be used by the network to co-schedule multiple UEs on the same OFDM time-frequency resources. For example, the network can select UEs that have reported different sets of DFT vectors with weak correlations. The CSI Type II report enables the UE to report a precoder hypothesis that trades CSI resolution against uplink transmission overhead.

NR 3GPP Release 15 supports Type II CSI feedback using port selection mode, in addition to the above normal reporting mode. In this case,
The base station transmits a CSI-RS port in each one of the beam directions.
The UE does not use a codebook to select a DFT vector, and thus a beam, instead the UE selects one or multiple antenna ports from the CSI-RS resource of multiple ports.

Type II CSI feedback using port selection gives the base station some flexibility to use non-standardized precoders that are transparent to the UE. For the port-selection codebook, the precoder reported by the UE may be described as follows

$${W}_{V} [ k ] = {\sum }_{n} {e}_{n} {a}_{n} {e}^{j {θ}_{n} [ k ]} .$$

Here, the vector e is a unit vector with only one non-zero element, which may be viewed as a selection vector that selects a port from the set of ports in the measured CSI-RS resource. The UE thus feeds back which ports it has selected, the amplitude factors and the co-phasing factors.

### Autoencoders for AI-Enhanced CSI Reporting

Recently neural network based autoencoders (AEs) have shown promising results for compressing downlink MIMO channel estimates for uplink feedback. That is, the AEs are used to compress downlink MIMO channel estimates. The compressed output of the AE is then used as uplink feedback. For example, prior art document Zhilin Lu, Xudong Zhang, Hongyi He, Jintao Wang, and Jian Song, “Binarized Aggregated Network with Quantization: Flexible Deep Learning Deployment for CSI Feedback in Massive MIMO System”, arXiv, 2105.00354 v1, May, 2021 provides a recent summary of academic work.

An AE is a type of neural Network (NN) that may be used to compress and decompress data in an unsupervised manner.

Unsupervised learning is a type of machine learning in which the algorithm is not provided with any pre-assigned labels or scores for the training data. As a result, unsupervised learning algorithms may first self-discover any naturally occurring patterns in that training data set. Common examples include clustering, where the algorithm automatically groups its training examples into categories with similar features, and principal component analysis, where the algorithm finds ways to compress the training data set by identifying which features are most useful for discriminating between different training examples and discarding the rest. This contrasts with supervised learning in which the training data include pre-assigned category labels, often by a human, or from the output of non-learning classification algorithm.

FIG. 4a illustrates a fully connected (dense) AE. The AE may be divided into two parts:
an encoder used to compress the input data X, and
a decoder used to recover important features of the input data.

The encoder and decoder are separated by a bottleneck layer that holds a compressed representation, Y in FIG. 4a, of the input data X. The variable Y is sometimes called the latent representation of the input X. More specifically,
The size of the bottleneck (latent representation) Y is smaller than the size of the input data X. The AE encoder thus compresses the input features X to Y.
The decoder part of the AE tries to invert the encoder's compression and reconstruct X with minimal error, according to some predefined loss function.

Aes may have different architectures. For example, Aes may be based on dense NNs like FIG. 4a, multi-dimensional convolution NNs, recurrent NNs, transformer NNs, or any combination thereof. However, all Aes architectures possess an encoder-bottleneck-decoder structure, like the one presented in FIG. 4a.

FIG. 4b illustrates how an AE may be used for AI-enhanced CSI reporting in NR during an inference phase, that is, during live network operation.
The UE estimates the downlink channel or important features thereof using configured downlink reference signal(s), e.g., CSI-RS. As mentioned above, important features of the channel may be eigenvectors of the channel or the Gram matrix of the channel, one or more eigenvectors that correspond to the largest eigenvalues of an estimated channel covariance matrix, one or more DFT base vectors (described on the next page), or orthogonal vectors from any other suitable and defined vector space, that best correlates with an estimated channel matrix, or an estimated channel covariance matrix, the channel delay profile). For example, the UE estimates the downlink channel as a 3D complex-valued tensor, with dimensions defined by the gNB's Tx-antenna ports, the UE's Rx antenna ports, and frequency units, the granularity of which is configurable, e.g., subcarrier or subband.
The UE uses a trained AE encoder to compress the estimated channel or important features thereof down to a binary codeword. The binary codework is reported to the network over an uplink control channel and/or data channel. In practice, this codeword will likely form one part of a channel state information (CSI) report that may also include rank, channel quality, and interference information.
The network uses a trained AE decoder to reconstruct the estimated channel or the important features thereof. The decompressed output of the AE decoder is used by the network in, for example, MIMO precoding, scheduling, and link adaption.

The architecture of an AE, e.g., structure, number of layers, nodes per layer, activation function etc, may need to be tailored for each particular use case. For example, properties of the data, e.g., CSI-RS channel estimates, the channel size, uplink feedback rate, and hardware limitations of the encoder and decoder may all need to be considered when designing the AE's architecture.

After the AE's architecture is fixed, it needs to be trained on one or more datasets. To achieve good performance during live operation in a network, the so-called inference phase, the training datasets need to be representative of the actual data the AE will encounter during live operation in the network.

The training process involves numerically tuning the AE's trainable parameters, e.g., the weights and biases of the underlying NN, to minimize a loss function on the training datasets. The loss function may be, for example, the Mean Squared Error (MSE) loss calculated as the average of the squared error between the UE's downlink channel estimate H and the network's reconstruction Ĥ, i.e., (H− [symbol] )². The purpose of the loss function is to meaningfully quantify the reconstruction error for the particular use case at hand.

The training process is typically based on some variant of the gradient descent algorithm, which, at its core, comprises three components: a feedforward step, a back propagation step, and a parameter optimization step. We now review these steps using a dense AE, i.e., a dense NN with a bottleneck layer. See FIG. 4a as an example.

Feedforward: A batch of training data, such as a mini-batch, e.g., several downlink-channel estimates, is pushed through the AE, from the input to the output. The loss function is used to compute the reconstruction loss for all training samples in the batch. The reconstruction loss may be an average reconstruction loss for all training samples in the batch.

The feedforward calculations of a dense AE with N layers (n=1, 2, . . . , N) may be written as follows: The output vector a^{[n]} of layer n is computed from the output of the previous layer a^{[n-1]} using the equations

$${z}^{[ n ]} = {W}^{[ n ]} \cdot {a}^{[ n - 1 ]} + {b}^{[ n ]} , {a}^{[ n ]} = g ( {z}^{[ n ]} ) .$$

In the above equation, W^{[n]} and b^{[n]} are the trainable weights and biases of layer n, respectively, and g is an activation function (for example, a rectified linear unit).

Back propagation (BP): The gradients, e.g., partial derivatives of the loss function, L, with respect to each trainable parameter in the AE, are computed. The back propagation algorithm sequentially works backwards from the AE output, layer-by-layer, back through the AE to the input. The back propagation algorithm is built around the chain rule for differentiation: When computing the gradients for layer n in the AE, it uses the gradients for layer n+1. This principle is illustrated in FIG. 4c illustrating how to use the autoencoder for CSI Compression in a training phase.

For a dense AE with N layers the back propagation calculations for layer n may be expressed with the following well-known equations

$$\frac{\partial L}{\partial {a}^{[ n ]}} = {[ {W}^{[ n + 1 ]} ]}^{T} \cdot \frac{\partial L}{\partial {z}^{[ n + 1 ]}} ,$$

$$\frac{\partial L}{\partial {z}^{[ n ]}} = \frac{\partial L}{\partial {a}^{[ n ]}} * {g}^{{[ n ]}^{′}} ( {z}^{[ n ]} ) ,$$

$$\frac{\partial L}{\partial {W}^{[ n ]}} = \frac{\partial L}{\partial {z}^{[ n ]}} \cdot {[ {a}^{[ n - 1 ]} ]}^{T} ,$$

$$\frac{\partial L}{\partial {b}^{[ n ]}} = \frac{\partial L}{\partial {z}^{[ n ]}} ,$$

where * here denotes the Hadamard multiplication of two vectors.

Parameter optimization: The gradients computed in the back propagation step are used to update the AE's trainable parameters. A simple approach is to use the gradient descent method with a learning rate parameter (α) that scales the gradients of the weights and biases, as illustrated by the following update equations

$${W}^{[ n ]} = {W}^{[ n ]} - α \cdot \frac{\partial L}{\partial {W}^{[ n ]}} , {b}^{[ n ]} = {b}^{[ n ]} - α \cdot \frac{\partial L}{\partial {b}^{[ n ]}} .$$

A core idea here is to make small adjustments to each parameter with the aim of reducing the loss over the (mini) batch. It is common to use special optimizers to update the AE's trainable parameters using gradient information. The following optimizers are widely used to reduce training time and improving overall performance: adaptive sub-gradient methods (AdaGrad), RMSProp, and adaptive moment estimation (ADAM).

The above steps (feedforward, back propagation, parameter optimization) are repeated many times until an acceptable level of performance is achieved on the training dataset. An acceptable level of performance may refer to the AE achieving a pre-defined average reconstruction error over the training dataset, e.g., normalized MSE of the reconstruction error over the training dataset is less than, say, 0.1. Alternatively, it may refer to the AE achieving a pre-defined user data throughput gain with respect to a baseline CSI reporting method, e.g., a MIMO precoding method is selected, and user throughputs are separately estimated for the baseline and the AE CSI reporting methods.

The above actions use numerical methods, e.g., gradient descent, to optimize the AE's trainable parameters, e.g., weights and biases. The training process, however, typically involves optimizing many other parameters, e.g., higher-level hyperparameters that define the model or the training process. Some example hyperparameters are as follows:
The architecture of the AE, e.g., dense, convolutional, transformer.
Architecture-specific parameters, e.g., the number of nodes per layer in a dense network, or the kernel sizes of a convolutional network.
The depth or size of the AE, e.g., number of layers.
The activation functions used at each node within the AE.
The mini-batch size, e.g., the number of channel samples fed into each iteration of the above training steps.
The learning rate for gradient descent and/or the optimizer.
The regularization method, e.g., weight regularization or dropout
   Additional validation datasets may be used to tune such hyperparameters.

### SUMMARY

Typically, the AE training process is a highly iterative process that may be expensive—consuming significant time, compute, memory, and power resources. Therefore, it may be expected that AE architecture design and training will largely be performed offline, e.g., in a development environment, using appropriate compute infrastructure, training data, validation data, and test data. Data for training, validation, and testing may be collected from one or more of the following examples:
real measurements recorded in live networks,
synthetic radio channel data from, e.g., 3GPP channel models or ray tracing models and/or digital twins, and
mobile drive tests.

Validation data may be part of the development and tuning of the NN, whereas the test data may be applied to the final NN. For example, a “validation dataset” may be used to optimize AE hyperparameters, like its architecture. For example, two different AE architectures may be trained on the same training dataset. Then the performance of the two trained AE architectures may be validated on the validation dataset. The architecture with the best performance on the validation dataset may be kept for the inference phase. In other words, validation may be performed on the same data set as the training, but on “unseen” data samples, e.g. taken from the same source. Test may be performed on a new data set, usually from another source and it tests the NN ability to generalize.

The training of the AE in FIG. 4c has some similarities with split NNs, where an NN is split into two or more sections and where each section consists of one or several consecutive layers of the NN. These sections of the NN may be in different entities/nodes and each entity may perform both feedforward and back propagations. For example, in the case of splitting the NN into two sections, the feedforward outputs of a first section are pushed to a second section. Conversely, in the back propagation step, the gradients of the first layer of the second section are pushed into the last layer of the first section.

The split NN, a.k.a. split learning, was introduced primarily to address privacy issues with user data. In the training of an AE for CSI reporting, however, the privacy, i.e., proprietary, aspects of the encoder and decoder sections are of interest, and training channel data may need to be shared to calculate reconstruction errors.

### Autoencoders for CSI Reporting—a Multi-Vendor Perspective

In AE-based CSI reporting, the AE encoder is in the UE and the AE decoder is in the wireless communications network, usually in the radio access network. The UE and the wireless communications network are typically represented by different vendors, or manufacturers or both, and, therefore, the AE solution needs to be viewed from a multi-vendor perspective with potential standardization, e.g., 3GPP standardization, impacts.

It is useful to recall how 3GPP 5G networks support uplink physical layer channel coding, e.g., error control coding.
The UE performs channel encoding and the network performs channel decoding.
The channel encoders have been specified in 3GPP, which ensures that the UE's behaviour is understood by the network and may be tested.
   The channel decoders, on the other hand, are left for implementation, and may thus be vendor proprietary.

If 3GPP specifies one or more AE-based CSI encoders for use in the UEs, then the corresponding AE decoders in the network may be left for implementation, e.g., constructed in a proprietary manner by training the decoders against specified AE encoders. FIG. 4d illustrates a network vendor training of an AE decoder with a specified untrainable AE encoder. In short and as described above, a training method for the decoder may comprise comparing a loss function of the channel and the decoded channel, or some features thereof, computing the gradients, which are partial derivatives of the loss function, L, with respect to each trainable parameter in the AE, by back propagation, and updating the decoder weights and biases.

Some fundamental differences between AE-based CSI reporting and channel coding are as follows:
Channel coding has a long and well-developed academic literature that enabled 3GPP to pre-select a few candidate architectures or types; namely, turbo codes, linear parity check codes, and polar codes. Channel codes may all be mathematically described as linear mappings that, in turn, may be written into a standard. Therefore, synthetic channel models may be sufficient to design, study, compare, and specify channel codes for 5G.
AEs for CSI feedback, on the other hand, have more architectural options and require many tuneable parameters, possibly hundreds of thousands. It is preferred that the AEs are trained, at least in part, on real field data that accurately represents live, in-network, conditions.

The standardization perspectives on AE-based CSI reporting may be summarized as follows:
AE encoder, or AE decoder, or both may be standardized in a first scenario,
   Training within 3GPP, e.g., NN architectures, weights and biases are specified,
   Training outside 3GPP, e.g., NN architectures are specified,
   Signalling for AE-based CSI reporting/configuration are specified,
AE encoder and AE decoder may be implementation specific, vendor proprietary in a second scenario,
   Interfaces to the AE encoder and AE decoder are specified,
   Signalling for AE-based CSI reporting/configuration are specified.

AE-based CSI reporting has at least the following implementation/standardization challenges and issues to solve:
The AE encoder and the AE decoder may be complicated NNs with thousands of tuneable parameters, e.g., weights and biases, that potentially need to be open and shared, e.g., through signalling, between the network and UE vendors.
The UE's compute and/or power resources are limited so the AE encoder will likely need to be known in advance to the UE such that the UE implementation may be optimized for its task.
   The AE encoder's architecture will most likely need to match chipset vendors hardware, and the model, with weights and biases possibly fixed, will need to be compiled with appropriate optimizations. The process of compiling the AE encoder may be costly in time, compute, power, and memory resources. Moreover, the compilation process requires specialized software tool chains to be installed and maintained on each UE.
   The AE may depend on the UE's, and/or network's, antenna layout and RF chains, meaning that many different trained AEs, and thus NNs, may be required to support all types of base station and UE designs.
The AE design is data driven meaning that the AE performance will depend on the training data. A specified AE, either encoder or decoder or both, developed using synthetic training data, e.g., specified 3GPP channel models, may not generalize well to radio channels observed in real deployments.
   To reduce the risks of overfitting to synthetic data, one may need to refine the 3GPP channel models and/or share a vast number of field data for training purposes. Here, overfitting means that the AE generalizes poorly to real data, or data observed in field, e.g., the AE achieves good performance on the training dataset, but when used in the real work, e.g. on the test set, it has poor performance.
In specifying either an AE encoder or an AE decoder, there may be a need for 3GPP to agree on at least one reference AE decoder or a respective encoder. These reference models will be needed to provide a minimal framework for discussions and specification work, but they may leave room for vendor specific implementations of the AE decoder (resp. encoder).

Given the above challenges and issues with multi-vendor AE-based CSI reporting, there is a need for a standardized procedure that enables joint training of the AE-encoder implemented by a UE/chipset vendor and the AE-decoder implemented by a network vendor. The joint training procedure may protect proprietary implementations of the AE encoder and decoder; that is, it may not expose details of the encoder and/or decoder trained weights and loss function to the other party.

A first reference method to train a network's AE decoders for receiving CSI reports in live networks and enabling proprietary AE encoders for CSI in the UE and also proprietary AE decoders in the network will be outlined in short below.

In the first reference method the network constructs a training dataset for each UE AE encoder by logging the UE's CSI report received over the air interface (the AE encoder output) together with the network's SRS-based estimate of the UL channel. The resulting dataset may then be used to train the network's AE decoder without having to know the UE's AE encoder since the network knows, from the dataset, both the input and the output of the encoder. This solution assumes that the CSI-RS based estimated downlink channel measured by the UE, i.e., the input to the AE encoder, may be well approximated by the uplink channel measured by the network using the SRSs.

Instead of supporting “fully proprietary AE encoders” in the UE, another second reference solution to the above problem may be to split the AE encoder into two parts—a UE proprietary part and a standardized part. More specifically, the UE vendor may implement a proprietary mapping, e.g., an NN, from the channel measurements on its receive antenna ports, e.g. the CSI-RS-based channel estimate, to a standardized channel feature space. The standardized channel feature space may be a latent representation of the channel designed using, for example, DFT basis vectors.

The first reference solution above enables proprietary AE encoders in the UE and proprietary AE decoders in the network, but it may have the following limitations:

The network's SRS-based estimate of the uplink channel is used as an approximate copy of the UE's CSI-RS-based estimate of the downlink channel (i.e., the input to the AE).
If there is only partial channel reciprocity, e.g., FDD deployment, then the SRS-based estimate will only include the channel's large-scale fading state, which may not be sufficient to enable MU-MIMO transmissions. The AE decoder may not learn to decode the small-scale fading state, which may impact MU-MIMO performance.
The UE may have fewer TX chains than RX chains, and, therefore, even in TDD, only partial channel reciprocity may be obtained, as the SRS-based channel estimate may only include some columns of the channel matrix.
The UE may have more downlink carriers than uplink carriers. Hence, some DL carriers do not have a corresponding uplink and SRS cannot be transmitted.
Commonly, the UEs are unable to maintain the same transmit power on all SRS antenna ports. The transmit power may vary several decibels over the SRS antenna ports, and the network may not know whether a faded channel measured on an SRS antenna port comes from the true channel or if it comes from a lower transmit power, compared to other SRS antenna ports. Hence, the channel measured on SRS does not perfectly reflect the downlink channel.
The AE encoder is UE implementation specific and, therefore, the network may have to deploy and maintain many different AE decoders—potentially one for each UE encoder. Supporting many UE AE encoder models may result in excessive training and model management costs.

A limitation of the approach outline in the second reference method may be that the decoder may only reconstruct standardized channel features. That is, any channel state information lost in the UE's proprietary mapping from its CSI-RS measurements to the standardized channel feature space may not be recovered by the BS.

An object of embodiments herein may be to obviate some of the problems related to training of AE in wireless communication networks. For example, a solution to the problems may be to standardize a development-domain training interface that enables different UE vendors to train their respective proprietary AE-based CSI encoders in a training phase together with proprietary AE-based CSI decoders. The development-domain may refer to a software/simulation-based environment used by a vendor to develop algorithms and functionality to be implemented in a product. The training interface may be an interface that enables interactions with another vendors development-domain to facilitate training together with that vendors AE-decoder.

The proprietary AE-based CSI encoders will be deployed later in first communication nodes, such as UEs, in a later inference phase also referred to as an operational phase or live phase. Similarly, the proprietary AE-based CSI decoders will be deployed in second communication nodes in communications networks from one vendor or different vendors.

Such a standardized training interface may include input/output interfaces of the CSI encoder that may be standardized as part of the air-interface together with necessary assistance information required for training.

The goal with the AE based CSI encoder-decoder system is to compress the CSI information in order to convey the channel measured by the UE (or features of the channel) in the downlink, to the network side over the air interface.

To train the AE encoder side only, the UE and/or chipset-vendor training apparatuses may not need to know the network vendor's AE decoder, the AE decoder output, the loss function, or the gradients of parameters within the decoder (excluding those in an encoder-decoder interface).

A development-domain interface may be standardized for communication between UE/chipset-vendor training apparatuses, and a network-vendor controlled training service provided by the second node 602, e.g., provided by the cloud. The interface may comprise at least the following signalling protocols, which are illustrated in FIG. 6:
A standardized format for signalling channel and/or channel feature data H from a channel data service, e.g., provided by the network vendor, the UE chipset vendor, or a third party, to UE and/or chipset-vendor training apparatuses and the second node 602.
A standardized format for signalling AE encoder outputs Y from a UE/chipset-vendor training apparatus to the second node 602.
A standardized format for signalling loss values L, or more generally, a measure of the performance of the system, from the second node 602 to a UE/chipset-vendor training apparatus.
A standardized format for signalling training assistance information, e.g., gradients of the loss with respect to the AE decoder input layer, from the second node 602 to the UE/chipset vendor training apparatus.

According to an aspect of embodiments herein, the object is achieved by a method, performed by a first node comprising an NN-based AE-encoder, for training the AE-encoder in a training phase of the AE-encoder. The AE-encoder is trained to provide encoded CSI, e.g., from a first communications node, such as a UE, to a second communications node, such as a radio access node, over a communications channel in a communications network. The communications channel may be a wireless communications channel. The CSI is provided in an operational phase of the AE-encoder, in which operational phase the AE-encoder is comprised in the first communications node. The method comprises:
providing AE-encoder data to a second node comprising a NN-based AE-decoder and having access to the channel data representing a communications channel between a first communications node and a second communications node, wherein the AE-encoder data includes encoder output data computed with the AE-encoder based on the channel data;
receiving, from the second node, training assistance information; and
determining, based on the training assistance information, whether or not to continue the training by updating encoder parameters of the AE-encoder based on the received training assistance information.

According to a second aspect, the object is achieved by a first node, the first node being configured to perform the method according to the first aspect.

According to a third aspect, the object is achieved by a method, performed by a second node comprising a Neural Network, NN,-based Auto Encoder, AE,-decoder, for assisting in training a NN-based AE-encoder comprised in a first node, in a training phase of the AE-encoder. The AE-encoder is trained to provide encoded Channel State Information, e.g., from a first communications node, such as a UE, to a second communications node, such as a radio access node, over a communications channel in a communications network. The communications channel may be a wireless communications channel. The CSI is provided in an operational phase of the AE-encoder, in which operational phase the AE-encoder is comprised in the first communications node.

The method comprises:
receiving AE-encoder data from the first node, wherein the AE-encoder data includes encoder output data;
and
providing training assistance information to the first node, the training assistance information is computed based on the encoder output data and based on channel data used by the AE-encoder (601-1) in the first node (601) to compute the encoder output data.

According to a third aspect, the object is achieved by a second node being configured to perform the method according to the third aspect.

According to a further aspect, the object is achieved by a computer program comprising instructions, which when executed by a processor, causes the processor to perform actions according to any of the aspects above.

According to a further aspect, the object is achieved by a carrier comprising the computer program of the aspect above, wherein the carrier is one of an electronic signal, an optical signal, an electromagnetic signal, a magnetic signal, an electric signal, a radio signal, a microwave signal, or a computer-readable storage medium.

The above aspects provide a possibility to enable different UE vendors to train their respective proprietary AE-based CSI encoders in a training phase together with proprietary AE-based CSI decoders.

### BRIEF DESCRIPTION OF THE DRAWINGS

In the figures, features that appear in some embodiments are indicated by dashed lines.

The various aspects of embodiments disclosed herein, including particular features and advantages thereof, will be readily understood from the following detailed description and the accompanying drawings, in which:

FIG. 1 illustrates a simplified wireless communication system,

FIG. 2 illustrates an example transmission and reception chain for MU-MIMO operations,

FIG. 3 is a block diagram schematically illustrating CSI type II normal reporting mode,

FIG. 4a schematically illustrates a fully connected, i.e., dense, AE,

FIG. 4b is a block diagram schematically illustrating how an AE may be used for AI-enhanced CSI reporting in NR during an inference phase,

FIG. 4c is a block diagram schematically illustrating how to use an autoencoder for CSI Compression in a training phase by backpropagation,

FIG. 4d is a block diagram schematically illustrating a network vendor training of an AE decoder with a specified, e.g., untrainable, AE encoder,

FIG. 5 illustrates a wireless communication system according to embodiments herein,

FIG. 6 is a block diagram schematically illustrating details of a first node and a second node according to embodiments herein,

FIG. 7 is a flow chart describing a method according to embodiments herein,

FIG. 8a is a schematic flowchart illustrating how a UE or chipset vendor training apparatus may train an AE encoder using the network vendor's training service provided by the second node,

FIG. 8b is a schematic flowchart illustrating details of the AE encoder feedforward propagation, the AE encoder backward propagation, and the updating of the AE encoder weights and biases,

FIG. 9 is a flow chart describing a method according to embodiments herein,

FIG. 10 is a block diagram schematically illustrating a first node according to embodiments herein,

FIG. 11 is a block diagram schematically illustrating a second node according to embodiments herein,

FIG. 12 schematically illustrates a telecommunication network connected via an intermediate network to a host computer.

FIG. 13 is a generalized block diagram of a host computer communicating via a base station with a user equipment over a partially wireless connection.

FIGS. 14 to 17 are flowcharts illustrating methods implemented in a communication system including a host computer, a base station and a user equipment.

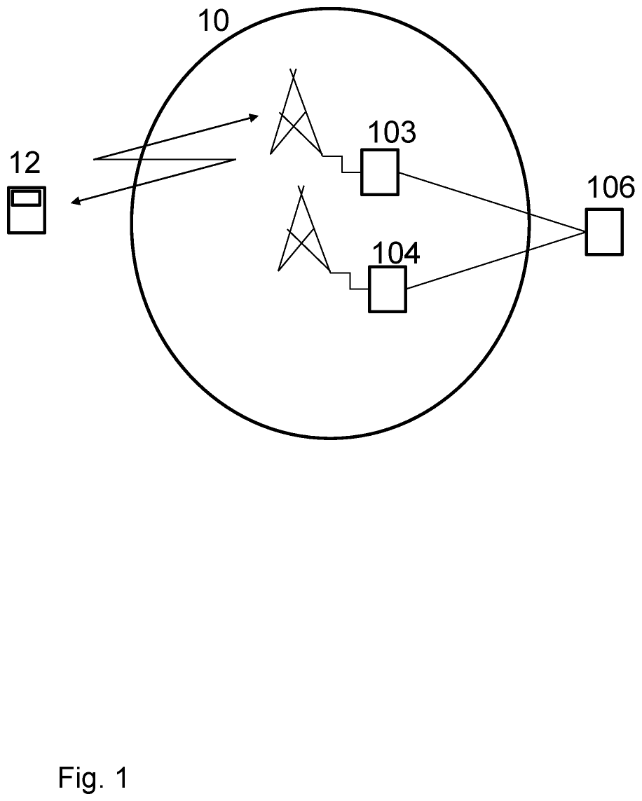

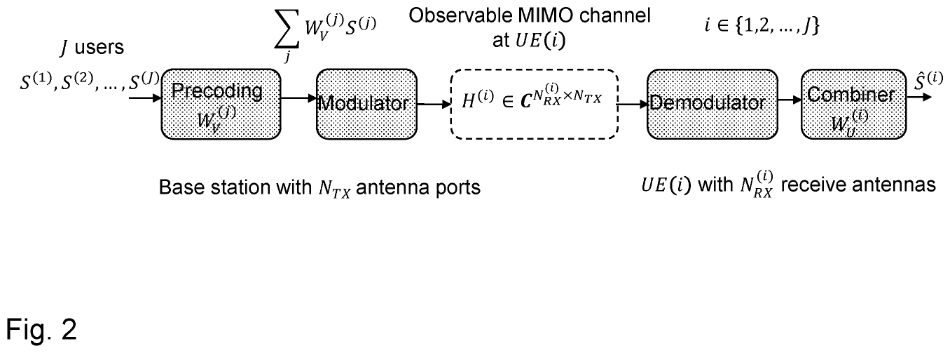

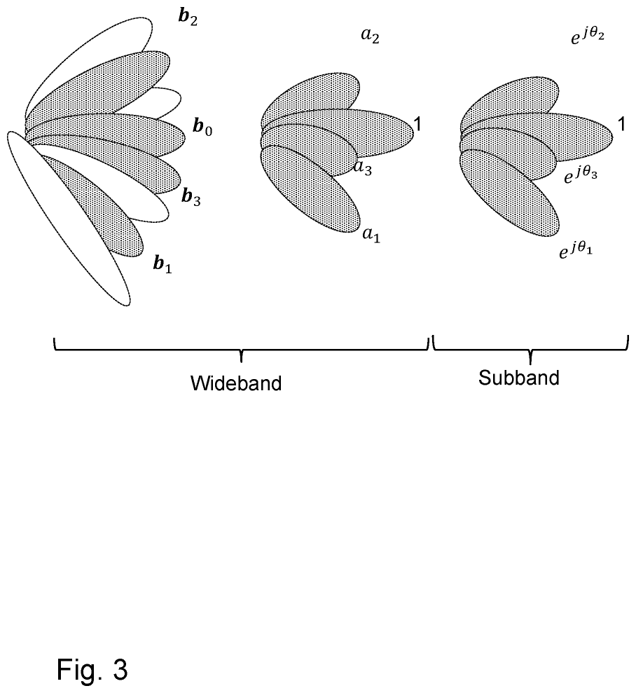

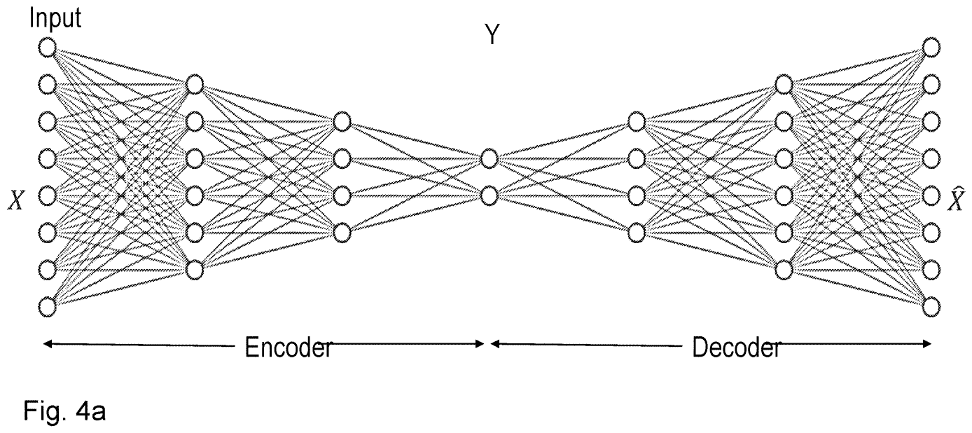

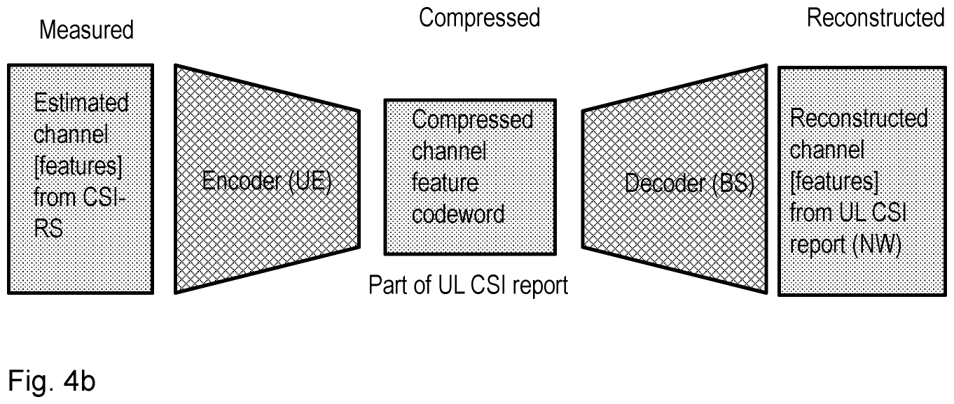

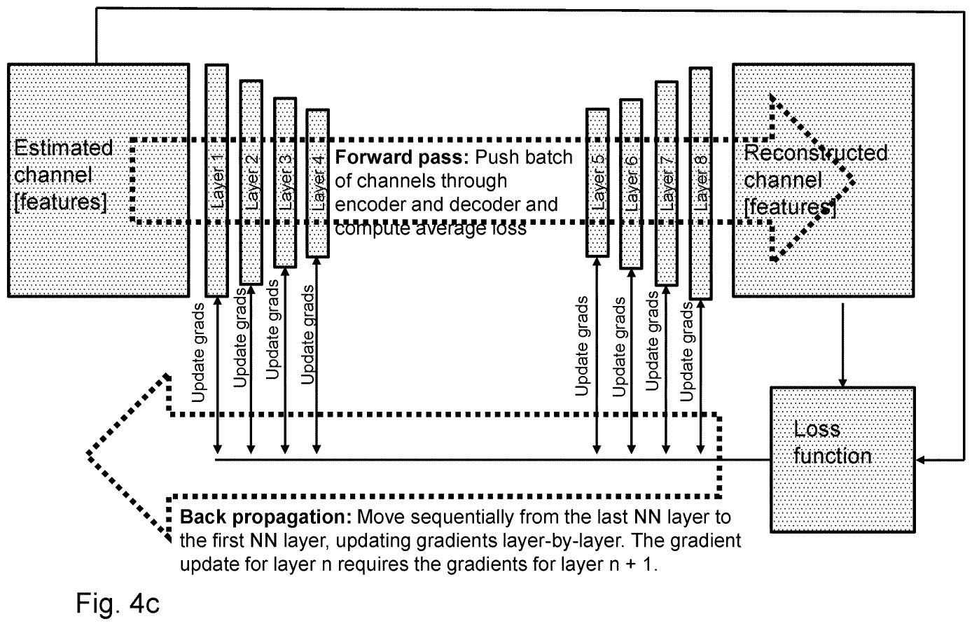

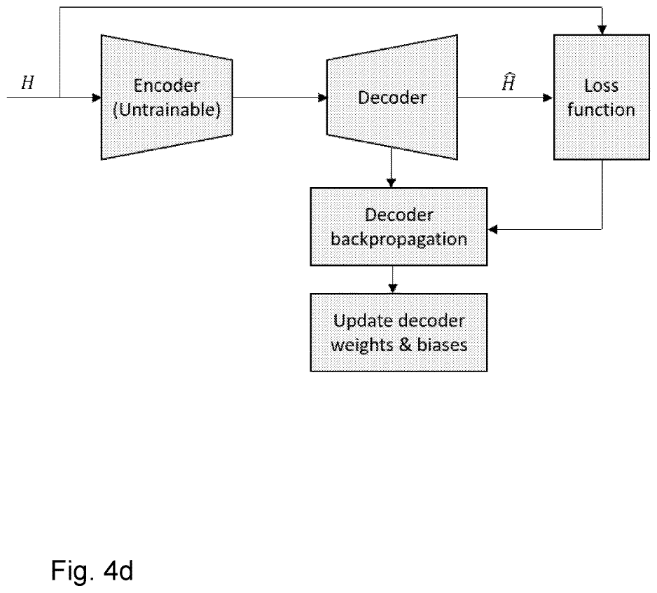

### DETAILED DESCRIPTION

As a part of developing embodiments herein the inventors identified a problem which first will be discussed. As mentioned above, there are challenges and issues with multi-vendor AE-based CSI reporting, for example how to protect proprietary implementations of the AE encoder and decoder while still providing an efficient encoded CSI reporting.

An object of embodiments herein is therefore to improve encoded CSI reporting in communications networks.

Embodiments herein disclose for example how to standardize a development-domain training interface that enables different UE vendors to train their respective proprietary AE-based CSI encoders together with proprietary AE-based CSI decoders to enable AE-encoded CSI reporting.

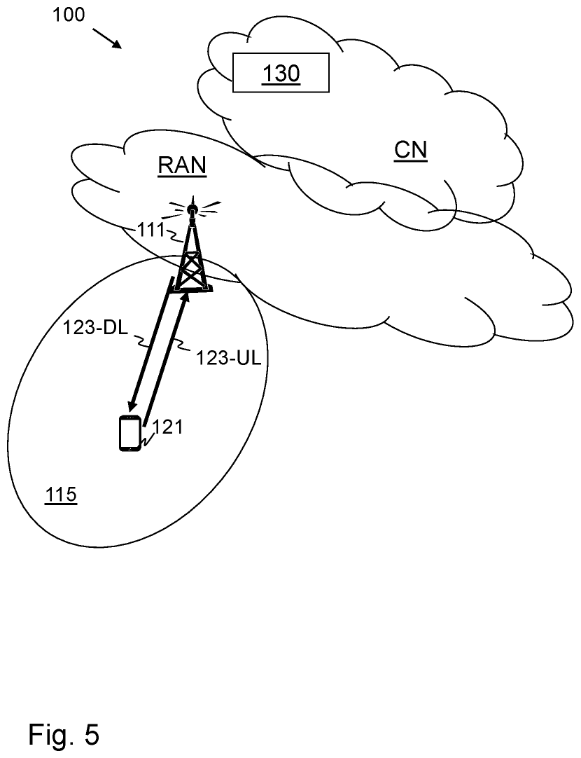

Embodiments herein relate to communication networks in general, and specifically to wireless communication networks. FIG. 5 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

Access nodes operate in the wireless communications network 100 such as a radio access node 111. The radio access node 111 provides radio coverage over a geographical area, a service area referred to as a cell 115, which may also be referred to as a beam or a beam group of a first radio access technology (RAT), such as 5G, LTE, Wi-Fi or similar. The radio access node 111 may be a NR-RAN node, transmission and reception point e.g. a base station, a radio access node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area depending e.g. on the radio access technology and terminology used. The respective radio access node 111 may be referred to as a serving radio access node and communicates with a UE with Downlink (DL) transmissions on a DL channel (123-DL) to the UE and Uplink (UL) transmissions on an UL channel (123-UL) from the UE.

A number of wireless communications devices operate in the wireless communication network 100, such as a UE 121.

The UE 121 may be a mobile station, a non-access point (non-AP) STA, a STA, a user equipment and/or a wireless terminal, that communicate via one or more Access Networks (AN), e.g. RAN, e.g. via the radio access node 111 to one or more core networks (CN) e.g. comprising a CN node 130, for example comprising an Access Management Function (AMF). It should be understood by the skilled in the art that “UE” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

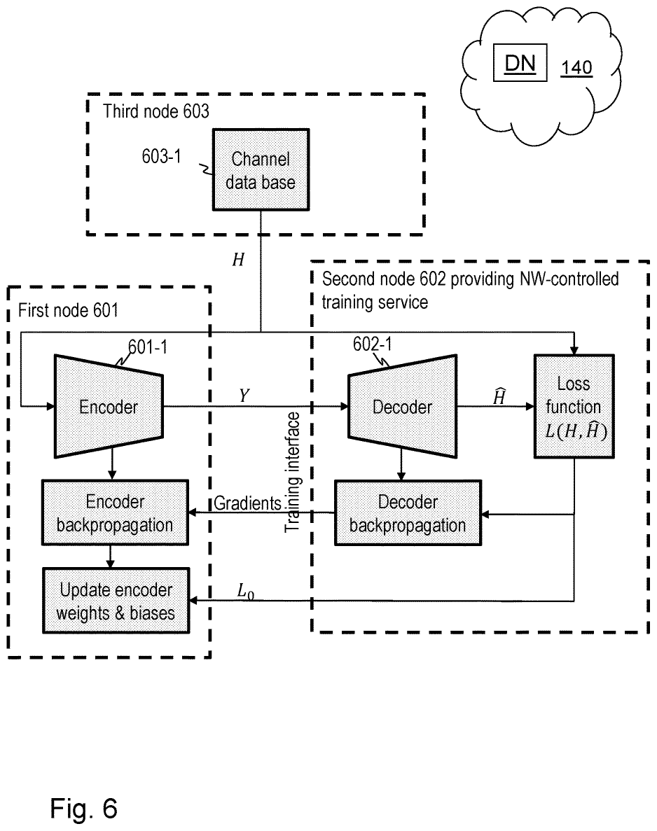

Embodiments herein will now be described in relation to FIG. 6. FIG. 6 illustrates a first node 601 comprising a Neural Network, NN,-based Auto Encoder, AE,-encoder 601-1. The first node 601 may also be referred to as a training apparatus.

The first node 601 is configured for training the AE-encoder 601-1 in a training phase of the AE-encoder 601-1. The AE-encoder 601-1 is trained to provide encoded CSI from a first communications node, such as the UE 121, to a second communications node, such as the radio access node 111, over a communications channel, such as the UL channel 123-UL, in a communications network, such as the wireless communications network 100. The CSI is provided in an operational phase of the AE-encoder wherein the AE-encoder 601-1 is comprised in the first communications node 121.

The implementation of the AE-decoder 602-1 may not be fully known to the first node 601. For example, the implementation of the AE-decoder 602-1 may be proprietary to the vendor of a certain base station. However, some parameters of the AE-decoder 602-1, like a number of inputs of the AE-decoder 602-1, may be known to the first node 601. Thus, the implementation of the AE-decoder excluding the encoder-decoder interface may not be known to the first node 601.

FIG. 6 further illustrates a second node 602 comprising an NN-based AE-decoder 602-1 and having access to the channel data. The second node 602 may provide a network-controlled training service for AE-encoders to be deployed in the first communications node 121, such as a UE. The NN-based AE-decoder 602-1 may comprise a same number of input nodes as a number of output nodes of the AE-encoder 601-1.

The first node 601 may have access to one or more trained NN-based AE-encoder models for encoding the CSI. The second node 602 may have access to one or more trained NN-based AE-decoder models for decoding the encoded CSI provided by the first node 602.

FIG. 6 further illustrates a third node 603 comprising a channel data base 603-1. The channel database 603-1 may be a channel data source.

In FIG. 6 the first node 601, the second node 602 and the third node 602 have been illustrated as single units. However, as an alternative, each node 601, 602, 603 may be implemented as a Distributed Node (DN) and functionality, e.g. comprised in a cloud 140 as shown in FIG. 6, and may be used for performing or partly performing the methods. There may be a respective cloud for each node.

FIG. 6 may also be seen as an illustration of an embodiment of a training interface between the second node 602 providing the network-controlled training service and the UE or chipset-vendor training apparatus 601. Details of the second node 602 and/or the network-controlled training service, such as a reconstructed channel R, a loss function, and a method to compute gradients may be transparent to the UE or chipset-vendor training apparatus 601.

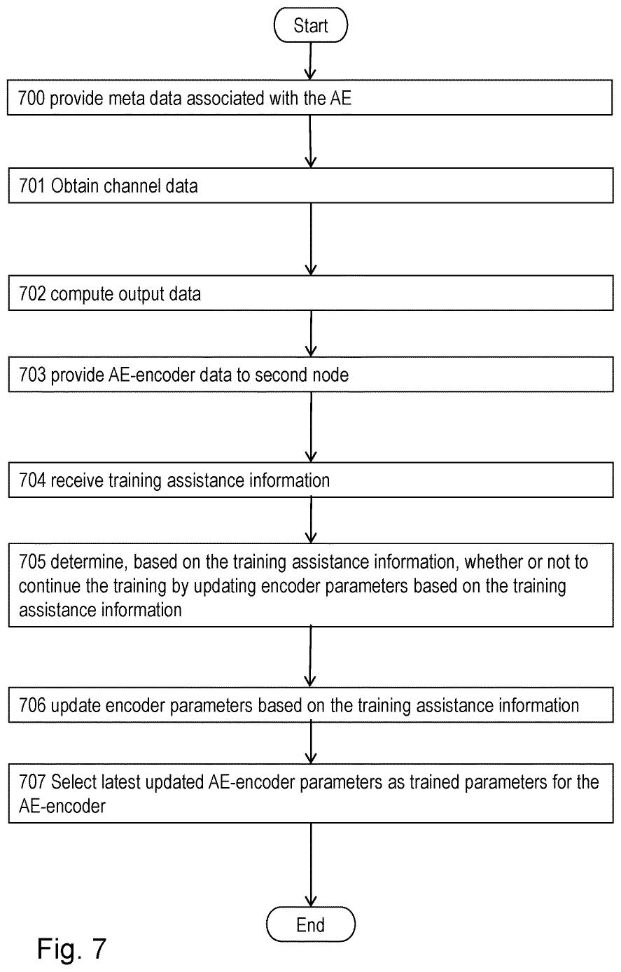

Exemplifying methods according to embodiments herein will now be described with reference to a flow chart in FIG. 7 and with continued reference to FIGS. 5 and 6. The flow chart illustrates a computer-implemented method, performed by the first node 601 for training the AE-encoder 601-1 in a training phase of the AE-encoder 601-1.

As a first optional action 700 of FIG. 7 the first node 601 provides the second node 602 with meta data associated with the AE. The meta data may comprise an indication of any one or more of:
a. an AE-encoder type or preferred AE-decoder type for the AE-encoder 601-1. The AE-encoder type or preferred AE-decoder type for the AE-encoder 601-1 may refer to an architecture. The preferred AE-decoder type may be of a same or corresponding type as the AE-encoder type;
b. a preferred loss function to use among a set of predefined loss functions;
c. a number of AE nodes in the output layer Y of the AE-encoder,
d. an indication to a reference AE-decoder architecture that the AE-encoder 601-1 has been pre-trained with;
e. a preferred method for data normalization; or
f. a method for quantizing AE-encoder outputs.

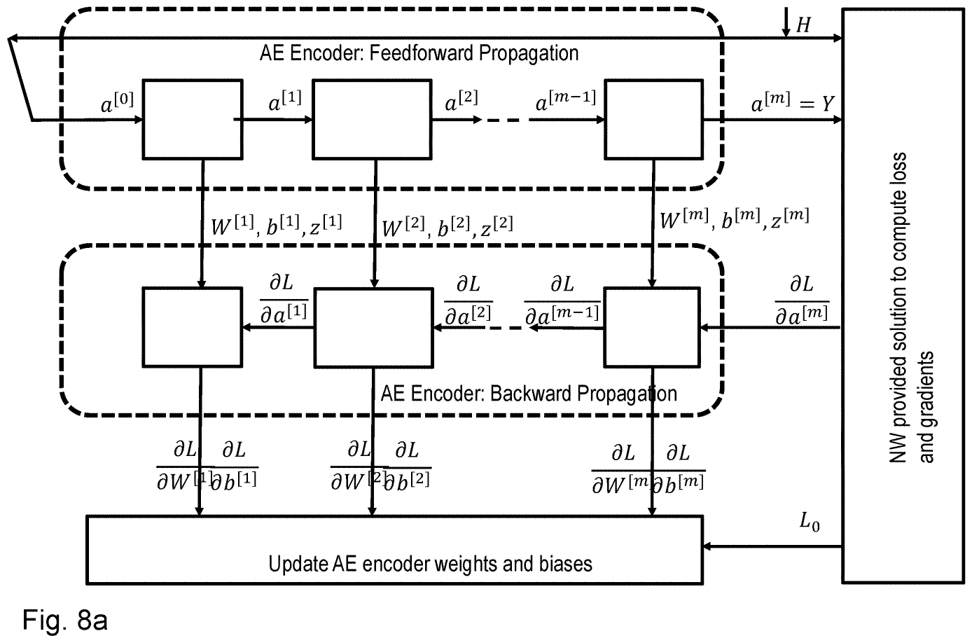

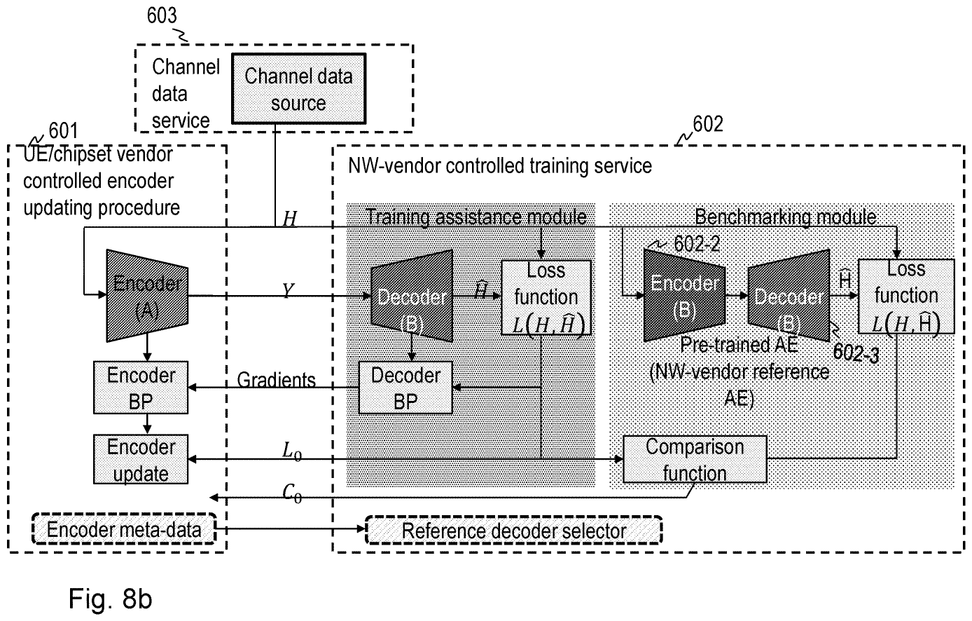

The meta data indication may be in the form of an AE-encoder type indicating at least one of the above examples. The use of the meta data will be explained in more detail below in association with FIG. 8b.

The AE-encoder type may indicate a preferred AE architecture from a list of predefined AE architectures. The reference AE-decoder architecture may be one of a list of predefined architectures.

In a next optional action 701 of FIG. 7, the first node 601 obtains the channel data from the second node 602, or the third node 603 comprising the channel data base 603-1.

In action 702 the first node 601 computes, with the AE-encoder 601-1, encoder output data based on channel data e.g., training channel data, representing the communications channel 123-DL between the first communications node 121 and the second communications node 111. The channel data is preferably real field data that accurately represents live, in-network, conditions. The channel data may also comprise features of the channel, such as DFT basis vectors.

In action 703 the first node 601 provides AE-encoder data to the second node 602 comprising the NN-based AE-decoder 602-1 and having access to the channel data representing the communications channel 123-DL between the first communications node 121 and the second communications node 111. The AE-encoder data includes the encoder output data computed with the AE-encoder 601-1.

The AE-encoder data may further include the channel data.

The format of the provided AE-encoder data may match a format of a CSI report comprising AE-encoded CSI from the first communications network node 121 to the second communications network node 111 in the operational phase.

In action 704 the first node 601 receives, from the second node 602, training assistance information. The training assistance information may comprise one or more of: a gradient vector of a loss function computed by the second node 602 with respect to a respective encoder parameter of the AE-encoder 601-1, a loss value of the loss function, an indication of the loss, an indication of whether or not the AE-encoder 601-1 has achieved sufficient training performance on the shared channel data when used with the AE-decoder 602-1 such that a pass criterion is fulfilled. The loss may quantify a reconstruction error of the shared channel data. The indication of the loss may for example be a relative value of the loss compared to a reference model AE-encoder as will be explained below in the detailed example embodiments.

The reconstruction error may be an error between the UE's downlink channel estimate and the network's reconstruction of the downlink channel estimate.

The shared channel data may comprise the UE's downlink channel estimate.

In action 705 the first node 601 determines, based on the training assistance information, whether or not to continue the training by updating encoder parameters of the AE-encoder 601-1 based on the received training assistance information.

Determining whether or not to continue the training may comprise determining whether or not a pass criterion of the loss parameter of the AE is fulfilled based on the received training assistance information. Here, the AE refers to the combination of the AE-encoder 601-1 and the AE-decoder 602-1.

If it is determined to continue the training, then in action 706 the first node 601 may update the encoder parameters based on the received training assistance information.

The encoder parameters may comprise any one or more of encoder trainable parameters: weights, biases, and hyperparameters such as a type of an architecture, and a number of nodes. Other encoder parameters that may be updated based on the training assistance information are: channel data batch size, learning rate, optimizer, e.g., adaptive moment estimation (ADAM), regularization method, e.g., dropout or weight based.

If it is determined to not continue the training, then in action 707 the first node 601 may select latest updated encoder parameters of the AE-encoder 601-1 as trained parameters for the AE-encoder 601-1. As mentioned above, the AE-encoder 601-1 is configured to provide the encoded CSI, based on the trained parameters, from the first communications node 121 to the second communications node 111 in an operational phase of the AE-encoder in which operational phase the AE-encoder (601-1) is comprised in the first communications node 121.

FIG. 8a illustrates how a UE or chipset vendor training apparatus, such as the node 601, may train an AE encoder 601-1 using the network vendor's training service provided by the second node 602.

Specifically, FIG. 8a illustrates details of the AE encoder feedforward propagation computing the output Y based on the input of the channel data H, the AE encoder backward propagation computing the gradients based on the gradients from the second node 602, and the updating of the AE encoder weights and biases based on the loss provided from the second node 602 and the AE encoder gradients.

In the following it assumed that the AE-encoder 601-1 is a dense feed-forward NN with m layers and a first layer of the AE-decoder 602-1 is dense.
The output of the AE, Y, is communicated to the second node 602, e.g., using the abovementioned standardized interfaces.
The second node 602 may be like a “black box” for the UE vendor. The second node 602 comprising the training service communicates the loss L and gradients, e.g., partial derivatives of the loss function, L, with respect to each trainable parameter in the AE,

$$\frac{\partial L}{\partial {a}^{[ m ]}} = {[ {W}^{[ m + 1 ]} ]}^{T} \cdot \frac{\partial L}{\partial {z}^{[ m + 1 ]}}$$

on the decoder input interface to the UE or chipset vendor training apparatus, e.g., the first node 601, e.g., using the abovementioned standardized interfaces.
The UE/chipset vendor training apparatus 601 may use a proprietary backpropagation algorithm to compute the gradients of each trainable parameter in the AE encoder 601-1. Note that the UE/chipset vendor training apparatus 601 only requires the gradients

$$\frac{\partial L}{\partial {a}^{[ m ]}} ,$$

i.e., the gradients of the input interface of the AE-decoder 602-1, to compute the gradients of the last layer, i.e., output layer/interface, of AE-encoder weights

$$\frac{\partial L}{\partial {W}^{[ m ]}} and biases \frac{\partial L}{\partial {b}^{[ m ]}} .$$

Using this information, the UE/chipset vendor training apparatus 601 may compute the gradients of the remaining weights and biases using a proprietary back propagation algorithm.
The UE/chipset vendor training apparatus 601 may update the AE encoder weights and biases using a proprietary optimizer.
The UE/chipset vendor training apparatus 601 may repeat the above process until a desired average loss performance is achieved.

### Detailed Example Embodiments

1. A first embodiment is directed to a method for training of the AE-encoder 601-1 in the first node 601, where the trained AE-encoder 601-1 is deployed to one or more UEs. The AE-encoder training may include the following:
   The first node 601 sends a batch of AE-encoder data to the second node 602, where the batch of AE-encoder data includes a batch of output data from the AE-encoder 601-1.
   The first node 601 receives AE-encoder update assistance information from the second node 602. This information is used to update the AE-encoder trainable parameters, e.g., the training information may be a gradient vector, a loss value, or other useful state information about the AE-decoder.
   The first node 601 updates trainable AE-encoder parameters and repeats the two above steps until a certain pass/fail criterion is fulfilled. For example, the second node 602 signals to the first node 601 the following:
      i. pass/fail indication (in terms of loss of the loss function),
      ii. a relative value of the loss compared to a reference model AE-encoder,
      iii. an absolute loss value.
2. A method in a dependent embodiment to the first embodiment, the batch of AE-encoder data further includes a batch of input data to the AE-encoder 601-1.
3. A method in a dependent embodiment to embodiment 1 or 2 above, wherein the first node 601 provides an AE-encoder type indicating at least one of the following:
   The AE-encoder type, e.g., architecture, or preferred AE-decoder type for the AE-encoder 601-1. A preferred AE-decoder type may be compatible with the AE-encoder 601-1. For example, the AE-decoder 602-1 may comprise a same number of input nodes as the number of output nodes of the AE-encoder 601-1. The preferred AE-decoder type may be of the same type as the AE-encoder 601-1. For example, the encoder 601-1 and the decoder 602-1 may both be of a dense NN type.
   a preferred loss functions to use among a set of predefined loss functions,
   number of nodes in the bottleneck layer that holds a compressed representation Y of the input data X.
   an indication to a reference AE-decoder architecture that the AE-encoder 601-1 has been pre-trained with. Then the second node 602 may know that the AE-encoder 601-1 has achieved good training results with the reference AE-decoder and may further compare training results with results from the reference decoder.
4. A method in a dependent embodiment to embodiment 3 above, wherein the AE-encoder or decoder type or both is one of at least: CNN, RNN, Dense, or transformer-based design.
5. A method in a dependent embodiment to embodiment 3 or 4 above, wherein the AE-encoder type indicates one of a list of predefined architectures of a preferred AE-encoder or decoder or both.
6. A method in a dependent embodiment to embodiment 3 above, wherein the reference AE-decoder architecture is one of a list of predefined architectures.

In a further embodiment the network vendor implements the training service, with the standardized interface illustrated in FIG. 6, in a cloud-based node, such as the second node 602 providing a cloud based AE training service. In this embodiment, the channel data service may be collocated with the UE/chipset training apparatus, such as with the first node 601.

The UE/chipset vendor training apparatus 601 may upload a batch of channel training data, and/or training data of features of the channel, such as DFT vectors, to the training service of the second node 602, together with the corresponding AE encoder outputs.

The second node 602 may complete the feedforward step and may compute the resulting loss. The second node 602 may use the standardized training interface to communicate the loss back to the UE/chipset vendor training apparatus 601.

In another embodiment the loss is normalized to take a value between 0 and 1.

In another embodiment, the loss is quantized to a specified number of discrete values.

In another embodiment, the method by which the loss is computed over batches or mini-batches of channels is standardized, e.g., the network proprietary loss function is averaged over samples within the batch or mini-batch.

The second node 602 may compute the gradients of each parameter in the input layer of the AE decoder 602-1. This may be done, for example, by running the standard back propagation algorithm through the AE decoder 602-1. The network vendor uses the standardized interface to communicate these gradients back to the UE/chipset vendor training apparatus 601.

In another embodiment, the AE decoder weights are also updated using the computed gradients.

The UE/chipset vendor training apparatus 601 may compute the remaining gradients for the AE encoder 601-1, using gradient-based information from the training service. This computation may be done, for example, by running a standard back propagation algorithm through the AE encoder 601-1. This idea is illustrated in FIG. 8a.

The UE/chipset vendor training apparatus 601 may use a proprietary optimization function to update the AE encoder weights. For example, the UE/chipset vendor training apparatus 601 may use adaptive sub-gradient methods (AdaGrad), RMSProp, or adaptive moment estimation (ADAM).

The above process may be repeated until a desired level of performance is achieved.

In another embodiment which is combinable with the embodiments above, the channel data service is co-located with the second node 602, i.e., the training service supplies channel training data to the UE vendor. The UE/chipset vendor training apparatus uploads AE encoder outputs to the training service, corresponding to the supplied channels.

In another embodiment, which is combinable with the embodiments above, the channel training data is provided to the UE/chipset vendor training apparatus 601 and the second node 602, by a third-party interface. The format and organization of the data may be specified.

In another embodiment, which is combinable with the embodiments above, the network-vendor training service is provided as software to the UE vendor. The software may be run in the second node 602, which may be controlled by the UE vendor. For example, the network-vendor provides the UE vendor with software that takes channel feature samples and AE encoder outputs as inputs and returns losses and gradients. In some other embodiments the first node 601 may run the provided software comprising the network-vendor training service.

In another embodiment, which is combinable with the embodiments above, a test dataset is shared, e.g., via a network-vendor controlled channel data service, and pass/fail signalling is included in the standardized interface. Pass/fail signalling may be used to inform the UE/chipset vendor training apparatus 601 that the AE encoder 601-1 has achieved sufficient performance, on the shared test dataset, to be used with the AE decoder 602-1.

In another embodiment, which is combinable with the embodiments above, where in addition the UE/chipset vendor training apparatus 601 also processes a batch of channel and/or channel feature validation data and push the corresponding AE encoder outputs to the network-vendor provided training service. The network vendor training service node 602 then returns an additional loss value.

As a pre-stage before the training processes starts the first node 601 wherein the AE-encoder 601-1 is running may provide a set of meta-data about the AE-encoder design, and possibly hyperparameter settings. The meta-data may be used by the second node 602 to select a reference decoder 602-3. This is illustrated in FIG. 8b.

In FIG. 8b the second node 602 comprises a special reference AE encoder 602-2 that it may use as a benchmark to evaluate the performance of the AE encoder 601-1 being trained in the first node 601. The special reference AE encoder 602-2 may be used together with a special reference AE decoder 602-3 also comprised in the second node 602.

If the AE encoder 601-1 being trained beats the performance of the reference AE encoder 602-2 inside and known to the second node 602, then the second node 602 may indicate to the first node 601 that the training may stop.

The meta-data may be one or more of the following:
the AE-encoder type or preferred AE-decoder type for the AE-encoder,
   The type may represent NN architecture options, for example a dense-, CNN-, RNN- or transformer-based design. It may further also represent a limited set of different predefined architecture designs. The architectures may give more details on the design in terms of depth of the design, layer design and so forth. The type may also control the number of NN nodes e.g., neurons or feature maps and their connections to the output layer (Y) of the AE encoder. The indication of a type of NN architecture is used to select an appropriate AE-decoder for being used within the training of the AE encoder. This selection is out of a set of AE-decoders that are available within the base station design.
a preferred loss functions to use among a set of predefined loss functions,
   examples of loss functions may be normalized MSE, with and without regularization, but may also be more elaborate loss functions that may be used to optimize a scheduling result.
number of nodes, e.g., neurons, in the last layer (Y) of the AE encoder 601-1, that may alternatively be given implicitly by indicating the quantization level of the AE encoder outputs.
an indication to a reference AE-decoder architecture that has been assumed in the design of the AE encoder 601-1, and possibly in a pre-training stage
   The reference AE-decoder 602-3 may have been used in the development of the AE-encoder 601-1. The reference AE-decoder 602-3 may further be specified in more details and used for verifying the performance of the AE-encoder 601-1. The indication of the reference AE-decoder 602-3 used for pretraining is an indication of what architecture options that has been selected for the AE-encoder 601-1 and may be used to pair with associated AE-decoder design for a base station.
A preferred method for data normalization, e.g., layers with batch norm operations.
A method for quantizing AE-encoder outputs, e.g., quantization method with corresponding gradient approximation.

Appropriate methods to assist training of the AE-encoder 601-1 in a training phase of the AE-encoder 601-1 are provided below.

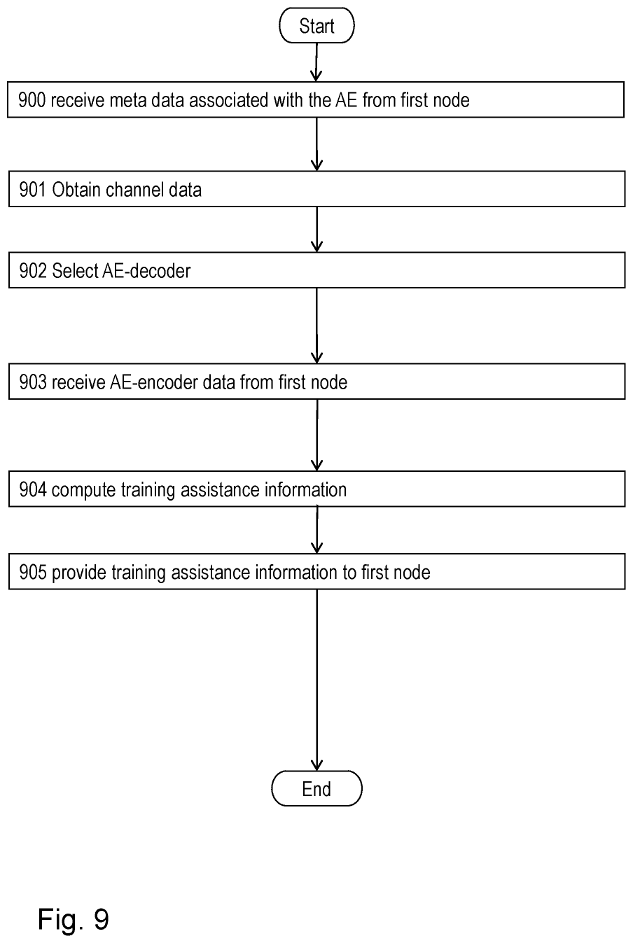

Exemplifying methods according to embodiments herein will now be described with reference to a flow chart in FIG. 9 and with continued reference to FIGS. 5 and 6. The flow chart illustrates a computer-implemented method, performed by the second node 602 comprising the NN-based AE-decoder 602-1, for assisting in training the NN-based AE-encoder 601-1 comprised in the first node 601, in the training phase of the AE-encoder 601-1.

The AE-encoder 601-1 is trained to provide encoded CSI from the first communications node 121 to the second communications node 111 over the communications channel 123-UL in the communications network 100.

The CSI is provided in an operational phase of the AE-encoder wherein the AE-encoder 601-1 is comprised in the first communications node 121.

As a first optional action 900 of FIG. 9 the second node 602 receives, from the first node 601, meta data associated with the AE.

In an optional action 901 the second node 602 obtains the channel data from the first node 601 or the third node 603 comprising the channel data database 603-1. The second node 602 may alternatively obtain the channel data from the channel data database which is comprised in or co-located with the second node 602.

In an optional action 902 the second node 602 selects an appropriate AE-decoder to be used for the training of the AE-encoder, based on the indication of the type of encoder and/or decoder type and/or architecture. For example, the second node 602 may select an AE-decoder 602-1 that is compatible with the AE-encoder 601-1. From the compatible AE-decoders the second node 602 may select an AE-decoder 602-1 that has an expected best performance with the AE-encoder 601-1. For example, the encoder 601-1 may have been trained with a set of decoders and then the second node 602 may decide which is the best decoder for this particular encoder. This selection may be out of a set of AE-decoders that are available for a base station design.

In action 903 the second node 602 receives AE-encoder data from the first node 601, wherein the AE-encoder data includes encoder output data.

In action 904 the second node 602 computes training assistance information based on the encoder output data and based on channel data used by the AE-encoder 601-1 in the first node 601 to compute the encoder output data

In action 905 the second node 602 provides the training assistance information to the first node 601.

Embodiments disclosed herein enable AI-based CSI reporting using network-proprietary AE decoders together with UE-proprietary AE encoders. Some advantages may be:
The AE decoder may be largely proprietary (implementation based). That is, only the input layer needs to be specified, which in a standardized solution anyway may need to be part of a standardized air-interface.
A proprietary AE decoder may be designed and trained offline, e.g., in a development environment, using proprietary algorithms, data, and infrastructure.
The loss function may be proprietary which avoids that the loss function reveals sensitive information about how the CSI is used for MU-MIMO precoding, scheduling, and link adaptation.
The AE encoders may be proprietary: They do not need to be standardized, nor do their architecture and/or parameters need to be revealed to the network.

Network vendors may compete on designing and training AE decoders. Network vendors may further compete on providing training services based on the above standardized development-domain training interface.

UE vendors may compete on training AE encoders for each network decoder.

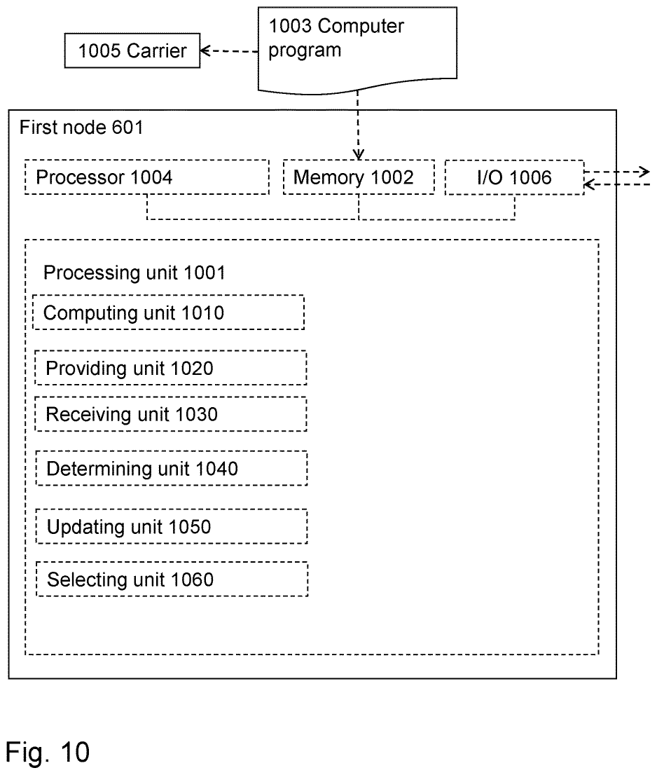

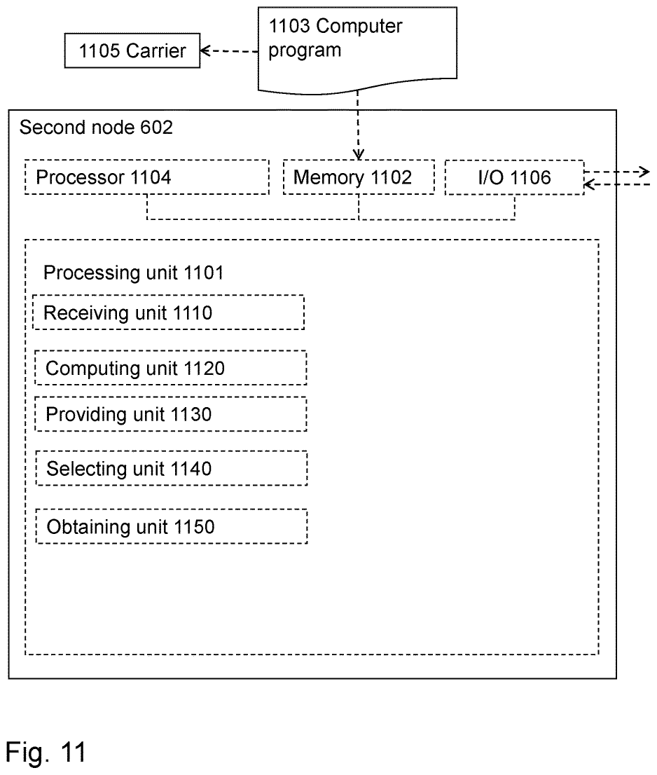

FIG. 10 shows an example of the first node 601 and FIG. 11 shows an example of the second node 602. The first node 601 may be configured to perform the method actions of FIG. 7 above. The second node 602 may be configured to perform the method actions of FIG. 9 above.

The first node 601 and the second node 602 may comprise a respective Input and output Interface, IF, 1006, 1106 configured to communicate with each other, see FIGS. 10-11. The input and output interface may comprise a wireless receiver (not shown) and a wireless transmitter (not shown).

The first node 601 and the second node 602 may comprise a respective processing unit 1001, 1101 for performing the above method actions. The respective processing unit 1001, 1101 may comprise further sub-units which will be described below.

The first node 601 and the second node 602 may further comprise a computing unit 1010, 1120 for AE computing. The computing unit 1010 of the first node 601 may compute encoder outputs based on encoder inputs, such as channel data and/or features of the channel data. The computing unit 1120 of the second node 602 may compute training assistance information.

The first node 601 and the second node 602 may further comprise a respective receiving unit 1030, 1110, and providing unit 1020, 1130, see FIGS. 10 and 11 which may receive and transmit messages and/or signals.

The first node 601 is configured to, e.g., by the providing unit 1020 being configured to, provide AE-encoder data to the second node 602 comprising the AE-decoder 602-1 and having access to channel data representing the communications channel 123-DL between the first communications node 121 and the second communications node 111. The AE-encoder data includes encoder output data computed with the AE-encoder 601-1 based on the channel data.

The first node 601 is further configured to, e.g., by the receiving unit 1030 being configured to, receive, from the second node 602, training assistance information.

The second node 602 is configured to, e.g., by the receiving unit 1110 being configured to, receive AE-encoder data from the first node 601. The AE-encoder data includes encoder output data.

The second node 602 is further configured to, e.g., by the providing unit 1130 being configured to, provide training assistance information to the first node 601. The training assistance information is computed based on the encoder output data and based on channel data used by the AE-encoder 601-1 in the first node 601 to compute the encoder output data.

The first node 601 may further comprise a determining unit 1040 which for example may determine, based on the training assistance information, whether or not the first node 601 is sufficiently trained. In other words, the first node 601 is further configured to, e.g., by the determining unit 1040 being configured to, determine, based on the training assistance information, whether or not to continue the training by updating encoder parameters of the AE-encoder (601-1) based on the received training assistance information.

The first node 601 may further comprise an updating unit 1050 and a selecting unit 1060. In some embodiments the first node 601 is further configured to, e.g., by the updating unit 1050 being configured to, update the encoder parameters based on the received training assistance information.

If it is determined to not continue the training, the first node 601 may further be configured to, e.g., by the selecting unit 1060 being configured to, select latest updated encoder parameters of the AE-encoder 601-1 as trained parameters for the AE-encoder 601-1 which is configured to provide the encoded CSI, based on the trained parameters, from the first communications node 121 to the second communications node 111 in the operational phase of the AE-encoder in which operational phase the AE-encoder 601-1 is comprised in the first communications node 121.

The second node 602 may further comprise a selecting unit 1140 and an obtaining unit 1150.

The second node 602 may further be configured to, e.g., by the selecting unit 1140 being configured to, select the appropriate AE-decoder to be used for the training of the AE-encoder, based on any one or more of the indication of the AE-encoder type, the preferred decoder type, and the reference AE-decoder architecture.

The second node 602 may further be configured to, e.g., by the obtaining unit 1150 being configured to, obtain the channel data from the channel data database which is comprised in or co-located with the second node 602.

The embodiments herein may be implemented through a respective processor or one or more processors, such as the respective processor 1004, and 1104, of a processing circuitry in the first node 601 and the second node 602, and depicted in FIGS. 10-11 together with computer program code for performing the functions and actions of the embodiments herein. The program code mentioned above may also be provided as a computer program product, for instance in the form of a data carrier carrying computer program code for performing the embodiments herein when being loaded into the respective first node 601 and second node 602. One such carrier may be in the form of a CD ROM disc. It is however feasible with other data carriers such as a memory stick. The computer program code may furthermore be provided as pure program code on a server and downloaded to the respective first node 601 and second node 602.

The first node 601 and the second node 602 may further comprise a respective memory 1002, and 1102 comprising one or more memory units. The memory comprises instructions executable by the processor in the first node 601 and second node 602.

Each respective memory 1002 and 1102 is arranged to be used to store e.g. information, data, configurations, and applications to perform the methods herein when being executed in the respective first node 601 and second node 602.

In some embodiments, a respective computer program 1003 and 1103 comprises instructions, which when executed by the processor 1004, 1104, cause the processor 1004, 1104 of the respective first node 601 and second node 602 to perform the actions above.

In some embodiments, a respective carrier 1005 and 1105 comprises the respective computer program, wherein the carrier 1005, 1105 is one of an electronic signal, an optical signal, an electromagnetic signal, a magnetic signal, an electric signal, a radio signal, a microwave signal, or a computer-readable storage medium.

Those skilled in the art will also appreciate that the units described above may refer to a combination of analog and digital circuits, and/or one or more processors configured with software and/or firmware, e.g. stored in the respective first node 601 and second node 602, that when executed by the respective one or more processors, such as the processors described above, perform the above-described methods. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

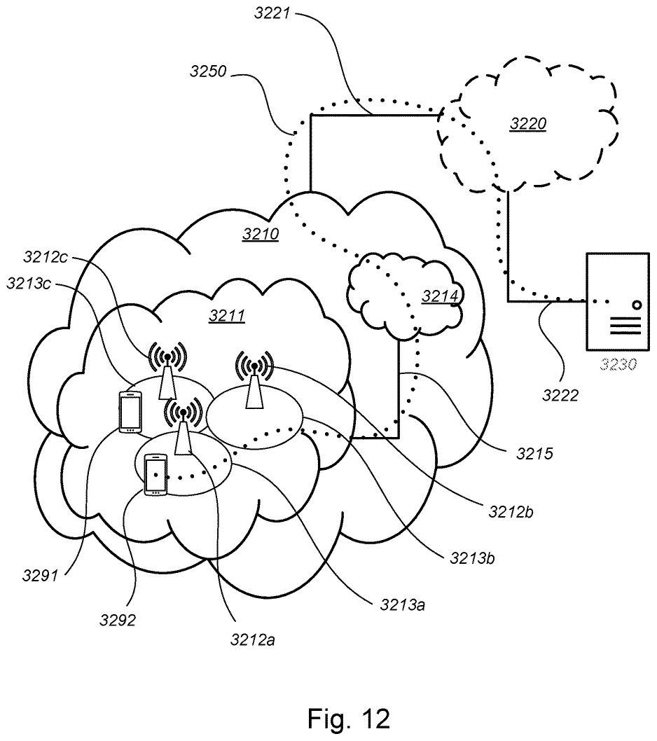

With reference to FIG. 12, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as the radio access node 111, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

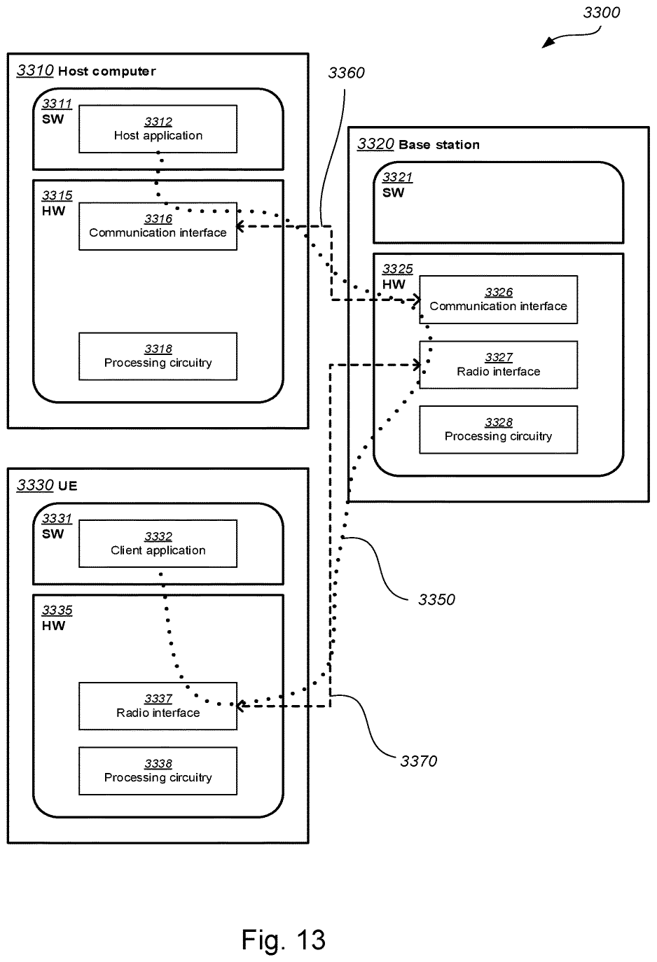

The communication system of FIG. 12 as a whole enables connectivity between one of the connected UEs 3291, 3292 such as e.g. the UE 121, and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230. Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 13) served by the base station 3320. The communication interface 3326 may be configured to facilitate a connection 3360 to the host computer 3310. The connection 3360 may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

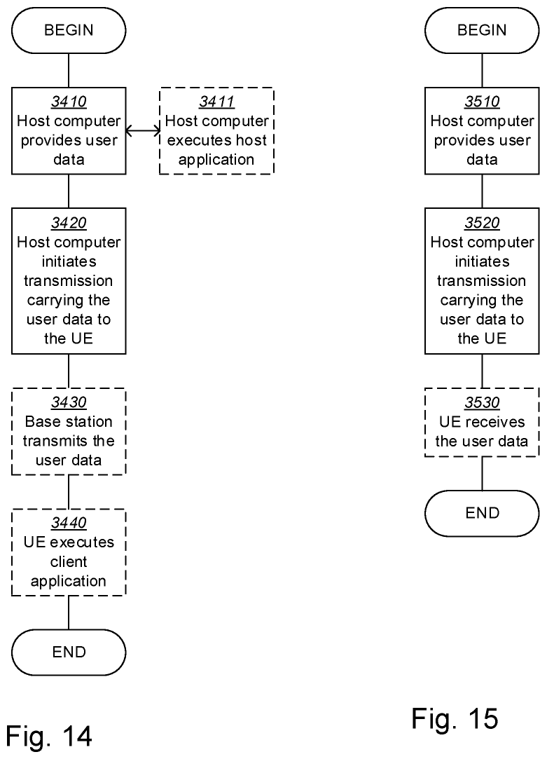

FIG. 14 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 14 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 15 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 15 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

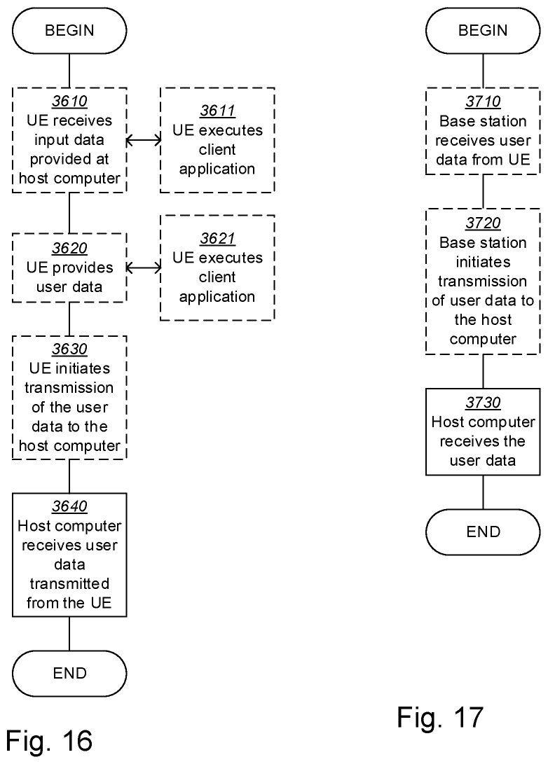

FIG. 16 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 16 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station such as a AP STA, and a UE such as a Non-AP STA which may be those described with reference to FIGS. 32 and 33. For simplicity of the present disclosure, only drawing references to FIG. 17 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above-described preferred embodiments. Various alternatives, modifications and equivalents may be used.

### Numbered Embodiments

1. A computer-implemented method, performed by a first node 601 comprising a Neural Network, NN,-based Auto Encoder, AE,-encoder 601-1, for training the AE-encoder 601-1 in a training phase of the AE-encoder 601-1, wherein the AE-encoder 601-1 is trained to provide encoded Channel State Information, CSI, from a first communications node 121, such as a UE, to a second communications node 111, such as a radio access node, over a communications channel 123-UL in a communications network 100, wherein the CSI is provided in an operational phase of the AE-encoder wherein the AE-encoder 601-1 is comprised in the first communications node 121, the method comprises:
   computing 702, with the AE-encoder 601-1, encoder output data based on channel data representing the communications channel 123-DL between the first communications node 121 and the second communications node 111;
   providing 703 AE-encoder data to a second node 602 comprising a NN-based AE-decoder 602-1 and having access to the channel data, wherein the AE-encoder data includes the encoder output data;
   receiving 704, from the second node 602, training assistance information; and
   determining 705, based on the training assistance information, whether or not to continue the training by updating encoder parameters of the AE-encoder 601-1 based on the received training assistance information.
2. The method according to embodiment 1, further comprising; if it is determined to continue the training, updating 706 the encoder parameters based on the received training assistance information.
3. The method according to embodiment 1, further comprising: if it is determined to not continue the training, selecting 707 latest updated encoder parameters of the AE-encoder 601-1 as trained parameters for the AE-encoder 601-1 which is configured to provide the encoded CSI, based on the trained parameters, from the first communications node 121 to the second communications node 111 in an operational phase.
4. The method according to any of the embodiments 1-3, wherein the training assistance information comprises one or more of: a gradient vector of a loss function computed by the second node 602 with respect to a respective encoder parameter of the AE-encoder 601-1, a loss value of the loss function, an indication of the loss, an indication of whether or not the AE-encoder 601-1 has achieved sufficient training performance on the shared channel data when used with the AE-decoder 602-1 such that a pass criterion is fulfilled, wherein the loss quantifies a reconstruction error of the shared channel data.
5. The method according to any of the embodiments 1-4, wherein the encoder parameters comprise any one or more of encoder trainable parameters: weights, biases, and hyperparameters such as a type of an architecture, and a number of nodes.
6. The method according to any of the embodiments 1-5, wherein determining whether or not to continue the training comprises determining whether or not a pass criterion of the loss parameter of the AE is fulfilled based on the received training assistance information.
7. The method according to any of the embodiments 1-6, wherein the AE-encoder data further includes the channel data.
8. The method according to any of the embodiments 1-7, further comprising: providing 700 the second node 602 with meta data associated with the AE, the meta data comprises an indication of any one or more of:
   a. an AE-encoder type or preferred AE-decoder type for the AE-encoder 601-1;
   b. a preferred loss function to use among a set of predefined loss functions;
   c. a number of AE nodes in the output layer Y of the AE-encoder,
   d. an indication to a reference AE-decoder architecture that the AE-encoder 601-1 has been pre-trained with;
   e. a preferred method for data normalization; or
   f. a method for quantizing AE-encoder outputs.
9. The method according to any of the embodiments 1-8, wherein the format of the provided AE-encoder data matches a format of a CSI report comprising AE-encoded CSI from the first communications network node 121 to the second communications network node 111 in the operational phase.
10. The method according any of the embodiments 1-9, wherein the implementation of the AE-decoder 602-1 is not known to the first node 601.
11. The method according to any of the embodiments 1-10, further comprising obtaining 701 the channel data from the second node 602, or a third node 603 comprising a channel data base.
12. The method according to any of the embodiments 8-11, wherein the AE-encoder type indicates a preferred AE architecture from a list of predefined AE architectures and/or wherein the reference AE-decoder architecture is one of a list of predefined architectures.
13. A computer-implemented method, performed by a second node 602 comprising a Neural Network, NN,-based Auto Encoder, AE,-decoder 602-1, for assisting in training a NN-based AE-encoder 601-1 comprised in a first node 601, in a training phase of the AE-encoder 601-1, wherein the AE-encoder 601-1 is trained to provide encoded Channel State Information CSI from a first communications node 121, such as a UE, to a second communications node 111, such as a radio access node, over a communications channel 123-UL in a communications network 100, wherein the CSI is provided in an operational phase of the AE-encoder wherein the AE-encoder 601-1 is comprised in the first communications node 121, the method comprising:
   receiving 903 AE-encoder data from the first node 601, wherein the AE-encoder data includes encoder output data;
   computing 904 training assistance information based on the encoder output data and based on channel data used by the AE-encoder 601-1 in the first node 601 to compute the encoder output data; and
   providing 905 the training assistance information to the first node 601.
14. The method according to embodiment 13, wherein the training assistance information comprises one or more of: a gradient vector of a loss function computed by the second node 602 with respect to a respective encoder parameter of the AE-encoder 601-1, a loss value of the loss function, an indication of the loss, an indication of whether or not the AE-encoder 601-1 has achieved sufficient training performance on the shared channel data when used with the AE-decoder 602-1 such that a pass criterion is fulfilled, wherein the loss quantifies a reconstruction error of the shared channel data.
15. The method according to any of the embodiments 13-15, wherein the encoder parameters comprise any one or more of encoder trainable parameters: weights, biases, and hyperparameters such as a type of an architecture, and a number of nodes.
16. The method according to any of the embodiments 13-16, further comprising: receiving 900, from the first node 601, meta data associated with the AE, the meta data comprises an indication of any one or more of:
   a. an AE-encoder type or preferred AE-decoder type for the AE-encoder 601-1;
   b. a preferred loss function to use among a set of predefined loss functions;
   c. a number of AE nodes in the output layer Y of the AE-encoder,
   d. an indication to a reference AE-decoder architecture that the AE-encoder 601-1 has been pre-trained with;
   e. a preferred method for data normalization; or
   f. a method for quantizing AE-encoder outputs.
17. The method according to any of the embodiments 13-17, further comprising: selecting 902 an appropriate AE-decoder to be used for the training of the AE-encoder, based on the indication of a type of encoder and/or decoder type and/or architecture. For example, the second node 602 may select an AE-decoder 602-1 that is compatible with the AE-encoder 601-1. From the compatible AE-decoders the second node 602 may select an AE-decoder 602-1 that has an expected best performance with the AE-encoder 601-1. This selection may be out of a set of AE-decoders that are available for a base station design.
18. The method according to any of the embodiments 13-18, further comprising obtaining 901 the channel data from the first node 601 or a third node 603 comprising a channel data database.
19. The method according to any of the embodiments 13-18, further comprising obtaining 901 the channel data from the channel data database which is comprised in or co-located with the second node 602.

1. A method, performed by a first node comprising an Auto Encoder, AE,-encoder, for training the AE-encoder to provide encoded Channel State Information, CSI, the method comprising:
providing AE-encoder data to a second node comprising an AE-decoder and having access to channel data representing a communications channel between a first communications node and a second communications node, the AE-encoder data including encoder output data computed with the AE-encoder based on the channel data;
receiving, from the second node, training assistance information; and
determining, based on the training assistance information, whether or not to continue the training by updating encoder parameters of the AE-encoder based on the received training assistance information.

2. The method according to claim 1, further comprising:
if it is determined to continue the training, updating the encoder parameters based on the received training assistance information.

3. The method according to claim 1, further comprising:
if it is determined to not continue the training, selecting latest updated encoder parameters of the AE-encoder as trained parameters for the AE-encoder which is configured to provide the encoded CSI, based on the trained parameters, from the first communications node to the second communications node in an operational phase of the AE-encoder in which operational phase the AE-encoder is comprised in the first communications node.

4. The method according to claim 1, wherein the training assistance information comprises one or more of: a gradient vector of a loss function computed by the second node with respect to a respective encoder parameter of the AE-encoder, an indication of the loss value of the loss function, an indication of whether or not the AE-encoder has achieved sufficient training performance on the channel data when used with the AE-decoder such that a pass criterion is fulfilled.

5. (canceled)

6. The method according to claim 1, wherein determining whether or not to continue the training comprises determining whether or not a pass criterion of the loss value of the AE is fulfilled based on the received training assistance information.

7. The method according to claim 1, wherein the AE-encoder data further includes the channel data.

8. The method according to claim 1, further comprising: providing the second node with meta data associated with the AE, the meta data comprises an indication of any one or more of:
an AE-encoder type or preferred AE-decoder type for the AE-encoder;
a preferred loss function to use among a set of predefined loss functions;
a number of AE nodes in the output layer (Y) of the AE-encoder;
an indication to a reference AE-decoder architecture that the AE-encoder has been pre-trained with;
a preferred method for data normalization; or
a method for quantizing AE-encoder outputs.

9. The method according to claim 1, wherein the format of the provided AE-encoder data matches a format of a CSI report comprising AE-encoded CSI from the first communications network node to the second communications network node in the operational phase.

10. The method according to claim 1, wherein the implementation of the AE-decoder is not known to the first node.

11. The method according to claim 1, further comprising obtaining the channel data from the second node, or a third node comprising a channel data base.

12. (canceled)

13. The method according to claim 1, wherein the AE-encoder is trained to provide encoded CSI from the first communications node to the second communications node over the communications channel in the communications network, wherein the CSI is provided in the operational phase of the AE-encoder.

14. A method, performed by a second node comprising an Auto Encoder, AE,-decoder, for assisting in training an AE-encoder, comprised in a first node, to provide encoded Channel State Information, CSI, the method comprising:
receiving AE-encoder data from the first node, the AE-encoder data including encoder output data; and
providing training assistance information to the first node, the training assistance information is computed based on the encoder output data and based on channel data used by the AE-encoder in the first node to compute the encoder output data.

15. The method according to claim 14, wherein the training assistance information comprises one or more of:
a gradient vector of a loss function computed by the second node with respect to a respective encoder parameter of the AE-encoder, a loss value of the loss function, an indication of the loss, an indication of whether or not the AE-encoder has achieved sufficient training performance on the shared channel data when used with the AE-decoder such that a pass criterion is fulfilled, wherein the loss quantifies a reconstruction error of the shared channel data.

16. (canceled)

17. The method according to claim 14, further comprising: receiving, from the first node, meta data associated with the AE, the meta data comprises an indication of any one or more of:
an AE-encoder type or preferred AE-decoder type for the AE-encoder;
a preferred loss function to use among a set of predefined loss functions;
a number of AE nodes in the output layer (Y) of the AE-encoder;
an indication to a reference AE-decoder architecture that the AE-encoder has been pre-trained with;
a preferred method for data normalization; or
a method for quantizing AE-encoder outputs.

18. (canceled)

19. The method according to claim 14, further comprising obtaining the channel data from the first node or a third node comprising a channel data database.

20. The method according to claim 14, further comprising obtaining the channel data from a channel data database which is comprised in or co-located with the second node.

21. A first node, comprising an Auto Encoder, AE,-encoder, configured for training the AE-encoder to provide encoded Channel State Information, CSI, the first node being further configured to:
provide AE-encoder data to a second node comprising an AE-decoder and having access to channel data representing a communications channel between a first communications node and a second communications node, the AE-encoder data including encoder output data computed with the AE-encoder based on the channel data;
receive, from the second node, training assistance information; and
determine, based on the training assistance information, whether or not to continue the training by updating encoder parameters of the AE-encoder based on the received training assistance information.

22. The first node according to claim 21, further configured to, if it is determined to continue the training, update the encoder parameters based on the received training assistance information.

23. A second node, comprising an Auto Encoder, AE,-decoder, configured for assisting in training an AE-encoder comprised in a first node, to provide encoded Channel State Information, CSI, the second node being further configured to:
receive AE-encoder data from the first node, the AE-encoder data including encoder output data; and
provide training assistance information to the first node, the training assistance information is computed based on the encoder output data and based on channel data used by the AE-encoder in the first node to compute the encoder output data.

24. The second node according to claim 23, wherein the training assistance information comprises one or more of:
a gradient vector of a loss function computed by the second node with respect to a respective encoder parameter of the AE-encoder, a loss value of the loss function, an indication of the loss, an indication of whether or not the AE-encoder has achieved sufficient training performance on the shared channel data when used with the AE-decoder such that a pass criterion is fulfilled, wherein the loss quantifies a reconstruction error of the shared channel data.

25. (canceled)

26. (canceled)
